(19) United States
(12) Patent Application Publication
(10) Pub. No.: US 2002/0094119 A1
(43) Pub. Date: Jul. 18, 2002

(54) High resolution digitized image analysis of chest x-rays for diagnosis of difficult to visualize evolving very ealrly stage lung cancer, pnumoconiosis and pulmonary diseases

(76) Inventor: Velayudhan Sahadevan, Beckley, WV (US)

Correspondence Address: Dr. V. Sahadevan, Dag Hammarskjold Cancer Treatment Center, 155 Dry Hill Road, Beckley, WV, 25802, US

(21) Appl. No.: 09/766,124

(22) Filed: Jan. 18, 2001

(51) Int. Cl. G06K 9/00

(52) U.S. Cl. 382/132

(57) ABSTRACT

A method and a system for high, super- and ultra-high resolution digitized image analysis of chest x-rays is provided for diagnosis of slowly evolving difficult to visualize early stage lung cancer and pulmonary diseases including very early stage diffuse pulmonary pneumoconiosis and silicosis. This method of digitized chest x-ray image analysis also facilitates the visualization of visceral, mediastinal and parietal pleura and the pericardium as separate distinct layers covering the lung and the heart. Such distinct imaging of those structures was not feasible by any other methods of imaging of the chest. Digital image enhancements allow presentation of important structures in the image in different colors and contrast. This method of high resolution digitized and software assisted chest x-ray analysis shows that it takes about 3-4 years before a lung cancer becomes distinctly visible in a chest x-ray. Chest x-ray is the most commonly used initial diagnostic imaging for the diagnosis of pulmonary diseases. Furthermore, it is a very cost-effective means for screening for early stage lung cancer and pulmonary diseases such as the pulmonary pneumoconiosis. This method of image analysis is facilitated by digitized image capture with high, super high and ultra-high resolution digital camera (28, 30, 32, 54, 64, 66) with very small pixels, image processing algorithms, a computer (138), a server (96) and printer (108) systems.

### CROSS REFERENCES TO RELATED APPLICATIONS

This patent is based upon my disclosure document NO. 456160, “Digital Image Conversion of Diagnostic Medical Imaging and Its Clinical Applications” filed on May 11, 1999, and continuation-in-part of my co-pending application Ser. No 09/572,557, filed May 16, 2000.

The file of this patent contains black and white and color images. The PTO upon payment of necessary fee will provide copies of the patent with black and white and color images.

### BACKGROUND

1. Field of Invention

This invention is in the field of medical imaging. The conventional screen film chest x-rays that are recorded onto films are digitized with high, super and ultra-high digital cameras. Close-up view digital macroscopy and digital analysis is used for improved early diagnosis of evolving lung cancer, worker's pneumoconiosis, silicosis and lung diseases.

2. Description of Prior Art

The digital analysis of diagnostic x-rays will increase the early diagnosis of various diseases. About 30% of clinically significant pulmonary nodules contained in a chest x-ray could be missed to read because of the contrast interference with similar structure (Computer-Aided Diagnosis of Pulmonary Nodules in Chest Radiographs: A Wavelet-Based Snake Approach by Yoshida, H., Keserci, B., and Doi, K., #1, in Eleventh IEEE Symposium on Computer-Based Medical Systems, 1998 p 258-263). Chest x-ray is the most commonly used initial radiological examination when pulmonary diseases including lung cancer is suspected. The chest CT and MRI are usually follow up examinations for further assessment of the chest x-ray findings. Therefore recognition of the early subtle changes in a chest x-ray could lead further assessment and diagnosis of early stage pulmonary diseases including an early stage lung cancer. The digitized images enhance the ability to detect the early pathological changes contained in a diagnostic imaging such as a chest x-ray. The digital analysis of the images reduces the chances of missing an important finding such as a developing very early stage cancer that may not be obvious in the conventional x-ray film. It can also aid to detect other diagnostically important changes that are associated with a specific disease. The digital computer analysis of the image helps to eliminate the contrast interference by other interfering structures in a screen film x-ray image. It also allows the electronic magnification, rotation, tonescale and histogram analysis, masking, sharpening and filtration of an image to enhance the visibility of the diagnostically significant elements in an image. It provides an easier means of storage of such images and their transmittal or distribution for distant consultation. Furthermore, the digital image offers many advantages over the conventional x-ray film image. It offers excellent control of the optical density of the final imaging by window adjustments. Such adjustment of different window levels allows bringing the optical density of the digitized image to a wide range to compensate the wide range of exposures used in image acquisition in radiography. Due to variations in patient's size, differences in tissue composition of an organ, the variations in exposure, KVP chemical processing the optical density of the screen film radiography would vary. The digitized screen-film radiograph's window adjustment can eliminate such variations in the optical density of screen film radiography.

Today there are many chest x-ray units in routine clinical practice that has no digital capability. If the advantages of the digital radiography can be introduced to these systems by indirect digitization of the radiographs taken by such radiographic systems. It can improve the diagnostic sensitivity of such x-ray units. The sequential comparative analysis of the previous chest x-rays and CT scans are routinely needed to make the differential diagnosis of a suspicious lesion in such images. The digitized images stored on to an electronic medium can facilitate such review easier. It will lead to improved early radiological diagnosis of diseases. There are two distinct methods for acquisition of a digital image. The first is the primary digital acquisition of an image. The second method involves the conversion of a conventional image to a digital image, the secondary or indirect digitization.

In primary digital image acquisition the information is gathered by direct passage of the x-ray photons through a region of interest like that of the lung in a chest x-ray. A true picture of the varying level of photon attenuation is represented in such primary digital image acquisition. It allows a true digital analysis of the acquired image and its computer assisted image manipulation for enhancement of those otherwise unobvious structures. It is the preferred clinical digital imaging but it cannot be applied to universally available radiographs obtained by conventional screen-film x-rays. Furthermore, such direct digitization has much lower resolution than that can be achieved by indirect digitization with newer very high, super and ultra high-resolution CCD digital cameras. If the directly digitized image has 100 μm sized pixels, it will have 5 line-pairs per mm and 10 pixels per mm. However, most often it has only 2.5 lp per mm and hence only 5 pixels per mm. The indirect digitization with a modern CCD camera can give resolutions ranging from 1600×1200 to 3,648×4,625 and with a view camera with CCD camera back like that of the Better Light's Super Model 8K could give high resolution of up to 8,000×10,660 at 24 color. It will give 132,184 pixels per mm if a 1×1-inch region of interest is digitized with such a super-high resolution CCD camera back. Its resolution can further increased to 15,990×12,000-pixel in 48-bit color. This Super 8K digital camera back at 100 percent resolution setting has 56 lp/mm and at 150 percent setting it has 83 lp/mm. The digitized images captured from radiographic films with such settlings can acquire the full lp resolution of the film used. (Professional digital cameras show impressive upgrades, PMA 2000 introductions provide new tools for digital photographers: Digital Imaging Digest May 2000, p 1-3. #2)

In the secondary digitization, the image contained in a conventional x-ray film is digitized. There are various methods for the secondary digitization of the x-ray film images. Using the older scanning methods for digitization the secondarily digitized image looses some of the information contained in the original image. When these older methods were used for digitization, the spatial and contrast resolution of the digitized image from a medium such as a x-ray film was lesser than those contained in a digital image acquired by primary digitization. However, the image obtained by this secondary digitization gave certain advantages over the conventional film images. Although its quality was poor, it could be used to improve the visualization of diagnostically critical picture elements that was unobvious in the original x-ray film image. It could be also used for computer assisted image analysis. The indirect digitization by means of laser scanning systems has poor image contrast due to its generally larger pixel sized image capture and image output. For example, the images captured with previously reported laser scanners have the pixel size of 0.2 mm or 200 microns. Such images when displayed at 12-bit depth have not enough contrast due to the larger pixel size. It contributes to the decreased detectability of conspicuousness lesions. Object contrast is related to pixel size and if an object has high enough contrast it can be detected even if it is smaller than a single pixel. The detectability of the smallest object and the shape of an object are also related to the pixel size. Because of the larger pixel size of the former laser scanners, the indirect digitization of screen film radiographs using such scanners were considered as insufficient to improve the visualization of the conspicuous lesions in screen-film chest x-rays.

For example, in a study on “Digital and Conventional Chest Images: Observer Performance with Film Digital Radiography System” by Goodman, L. R., Foley, W. D., Wilson C. R., Rimm A. A., and Lawson T. L., Radiology, 158; 27-33, #3, a film digital radiography system consisting of a laser scanner with a resolution of 1680×2000 pixels from a 14×17-inch film for digitization was used. The digitized image sampling had 2.5 line pairs/mm giving a 0.2 mm pixels that is 200 microns. The digitized video image was displayed on a 1000×1000 line monitor at 1.25 line pairs/mm giving 0.4 mm pixel at 1× magnification and 2.5 line pairs giving 0.2 mm pixel at 2× magnification at 12 bit depth without tonal reversal or magnification for reading of the chest x-rays. Overall, the digitized image with this film digital radiography system was not superior to conventional film chest x-rays. However there was a tendency to visualize mediastinal structures by digitized image's positive presentation. This laser scanning based system lacked the advantages of a larger CCD digital camera. It was clearly inferior to a larger video format CCD based digital cameras, which gives incredibly sharp images. Such CCD based system presents more information that is already contained in the source image by its digitization due to its much smaller pixels, high resolution, its image processing with advanced image processing software and faster SCSI based image transfer and computing. The poor results obtained with this system are related to the poor performance of the laser based scanning system. The digitized images published in this study appeared as less sharper and structures less defined than when digitized images captured with a domestic TV camera like a camcorder and a frame grabber and processed with an image processing software. This difference is related to the difference in pixel size of the laser scanning and camera-based digitization of the source image.

In an article on Digital Luminescence Radiography in Interstitial Lung Disease A receiver operating characteristics (ROC) analysis by Kehler, M., Albrechtsson, U., Andresdottir, A., Bradvik, I. et.al. Acta Radiologica 32: 1823, 1991, #4), the digitization was done with a photo stimulable phosphor as the intermediate receptor. This phosphor-coated plate is first exposed to radiation and then the stored-energy latent image is read by a scanning laser, which releases the stored energy in the form of light, which can be recorded in a digital format. Two types of digitized image were generated, the one simulating the conventional radiograph and the other as contrast enhanced (unsharp masked) image. In this study, the digitized image and the conventional radiograph were equal in diagnostic performance. Thus this system could not provide any significant diagnostic advantage over the conventional film radiograph. Like before, the poor results obtained with this system is related to the poor performance of the laser based scanning system. Here also the digitized images published in this study appeared as less sharper and structures less defined than when digitized images were captured with a simpler domestic TV camera like a camcorder combined with a frame grabber and processed with a present day image processing software. This difference may be related to the difference in laser scanning with the pixel size of 0.2×0.2 mm, that is 200 micron sized pixels with the resolution of 2.5 line pairs (lp)/mm. The high resolution CCD digital camera has the pixel size of about 7 microns or lesser.

Similarly, the article “High Frequency Edge Enhancement in the Detection of Fine Pulmonary Lines Parity Between Storage Phosphor Digital Images and Conventional Chest Radiography” by Oesterman, J. W., Green R., Rubens, J. R. et.al.in Invest Radiol 1989; 24:643-646,1989 #5, describes of a laser scanning based method for digitization of chest radiographs derived from a photostimulable phosphor as an intermediate receptor. Its resolution was 1760×2140 matrix, 10-bit depth. The digitized images were transferred to a transparency with a laser printer. The digitized conventional radiograph and the digitized, edge enhanced conventional radiographs of the chest were compared with the conventional film chest radiographs for their relative diagnostic performance for the detection of fine pulmonary lines. In this study also the average diagnostic performance of the digitized edge enhanced images was identical to those of the conventional film radiograph of the chest. The non-edge enhanced digitized images had poor diagnostic performance than the edge enhanced digitized images. Thus no overall significant advantage by digitized analysis of the chest x-rays was found in this study due to the laser scanning system used in this study. The laser scanning system provides very low line pairs/mm as compared to a standard film x-ray. The average line pairs obtained is 2.5/mm that is 0.2 mm sized pixels by the laser scanning system while the film x-ray can have about 17-20 line pairs per mm and thereby much smaller pixels. It has no comparative advantage when the images are digitized with a modern high-resolution larger CCD digital camera with pixel size in the range of 16.6 mm.

In an article by Macmahon, H., Vyborny, C. J., Metz, C. E. Doii, K., Sabeti, V. and Solomon, S. L.; Subtle Pulmonary Abnormalities; Digital Radiography of Subtle Pulmonary Abnormalities: A ROC Study of the Effect of Pixel Size on Observer Performance; Radiology 158:21-26 1986; 158: 21-26; 5 pgs #6, it was described that when pixel size greater than 0.1 mm in the digitized chest x-ray images, some loss of diagnostic accuracy will result. The diagnostic accuracy increases substantially as the pixel size is reduced, at least to 0.1 mm level. The screen-film chest x-rays were digitized to 1,024 gray level resolution (10 bits) per pixel. The system used for the digitization had much lesser capabilities compared to a larger CCD digital cameras with higher resolution.

In an article, on “Spatial Resolution Requirements for Digital Chest Radiographs: A ROC Study of Observer Performance in Selected Cases” in Radiology 158:11-19 (1986) by Lams, P. and Cocklin, M. #7, a scanning microdensitometer was used to obtain film chest radiograph's digitized images. With this digitization means, only a portion of a chest x-ray could be displayed on a 1,024-line monitor. It had 0.8-mm pixel that is 800 microns, and hence the fine septal details of the lung could not be visualized in the digitized image. Obviously, it also has no comparative advantage when the images are digitized with a modern high-resolution larger CCD digital camera with the pixel value in the range of about 7 microns or lesser.

In U.S. Pat. No 5,0416,118 the conventional screen film x-ray image or the latent image obtained from a storage phosphor based system is first converted to digital image for its initial tone-scale transformation. In the case of the latent image storage phosphor based system, the image is scanned with a scanner with laser beam, lens, photodetector, signal amplifier and an analog to digital (A/D) converter for the digital conversion of the input image. The converted digital image is stored onto a magnetic tape or sent directly to a digital image processor. In the case of the conventional film/screen image, it uses a different scanner for the digital conversion of the image. In this case, the light is transmitted through the image containing film and is collected by the photo detector. It is then processed as in the case of latent image of the type of the storage-phosphor-based system. After the digitized image is analyzed by a tone-scale transformation function with the aid of a look up table, the image is converted back to analog signal and printed onto a photographic film as tone-scale transformed image. This older laser scanning based system lacked the advantages of the present smaller pixel sized high resolution laser scanners or the larger CCD digital scanners or the higher resolution CCD cameras with higher bit depth. The U.S. Pat. No. 5,164,993 uses a similar system of apparatus as in U.S. Pat. No. 5,0416,118 to process the conventional screen film x-ray or the storage phosphor based image to a digital image and its conversion to analog to digital and back to digital to analog image. Both these patents teach methods for tonescale transformation of digitized image. It has the same disadvantages as the U.S. Pat. No. 5,0416,118. The U.S. Pat. No. 5,268,967 teaches on digital conversion of conventional images like the storage phosphor based systems, screen/film, CT, MRI etc by scanning as in U.S. Pat. Nos. 5,0416,118 and 5,164,993. The scanned digitized images are then processed for edge detection, block generation, block classification and bitmap generation etc. It also suffers the disadvantages of the other two patents. In U.S. Pat. No. 4,731,863 the conventional medical image is digitized and such digitized image is processed by histogram peak detection. Like the other U.S. Pat. Nos. 5,0416,118, 5,164,993 and 5,268,967 its teachings also have similar disadvantages. U.S. Pat. No. 4,814,606 teaches of an improved laser scanning systems for film digital radiography. It also suffers the disadvantages of the older laser scanning systems with larger pixels. They all also have the disadvantages associated with image size and resolution. Smaller the image, lesser the x-axis lines and therefore lesser the resolution. Recently, much advancement has been made in the development of larger charge coupled devices (CCD) digital cameras. The earlier experiments in this study were performed with a high-resolution larger CCD digital camera, the Polaroid DMC le digital camera. It has a 12.15-mm CCD that is larger than a 2/3-inch video format CCD. Its pixel size is 16.6 microns. Compared to the best laser scanning digitizers with 2.5 line pairs per mm that gives a 0.2 mm pixel, that is 200-micron pixel this 12.15 mm CCD based digital camera's pixel size is 16.6 microns or 12 times smaller. From this it could be extrapolated that about 2.5×12 line pairs that is 30 line pairs per mm is possible. Needless to say that such small pixel size and that many line pairs per mm would significantly enhance the contrast of the objects contained in an image digitized with this high performance CCD digital camera. The theoretical spatial resolution of the x-ray film is very high. There are films that can resolve 17 to 20 line-pairs per millimeter that should theoretically allow the detection of objects that are as small as 25 μm in size. With about 30 line pairs per mm in 12.15 mm CCD digital camera, the object recognition in its digitized image is further improved than that of a film with 17-20 line pairs. It captures images at 12 bit linear RGB. It's output resolutions can be varied from 400×300, 800×600-and 1600×1200, which further improves the digitized images visualization quality. The output pixel depth can be adjusted to resolutions of 8 bit, 16 bit, 24 bit or 48 bit. It captures full image without compression and hence there is no danger of loosing image data when the captured image is transferred to the computer. Its software allows the capture of images in industry standard TIFF file format which can be transferred to other image processing software for further image analysis. On-screen digital image previewing is fast, up to five times per second. Under the software control, the image size, contrast and brightness, gamma and sharpness all can be adjusted for the fine detailed view of the digitized image. The other such CCD digital cameras with similar capabilities and even with higher resolution includes the Sony DKC-ST5 digital camera which captures digitized image at 2560×2048 pixels, the line-scanning tri-linear CCD digital cameras which captures digitized images at even much higher resolutions ranging from 2700×3380 pixels to 3648×4625 pixels. The Microlumina digital camera with 2700 CCD element, tri-linear, RGB with dynamic 12 bits/pixel/channel (36 bit total pixel color depth) has a resolution of 2700×3380 pixels and pixel size of 10 microns. The tri-linear CCD Kaiser Scando Dyn A+digital camera has a resolution of 3648×4625 pixels and pixel size of 8 microns. The very recently released Better Light Super 8k digital camera has resolution of up to 12,000×15,990 pixels. At its resolution setting of 8,000×10660 pixels, it will give 132,184 pixels per mm of 1×1-inch region of interest. Even smaller pixel sized digital cameras with octagonal pixels than the conventional rectangular pixels like the newer Fujifilm's FinePix S1 Pro Super CCD digital camera with pixels positioned at 45° angle gives much increased sensitivity, signal/noise ratio and dynamic range. Its 23.3×15.6 mm super CCD sensor and image file sizes of 3,040×2016/2,304×1,536 pixels/1,440×960 pixels are of distinct advantages over the conventional CCD digital cameras with conventional CCD pixels. Indirect digitization with such super high resolution digital cameras and image display at high or super high resolutions CCD digital cameras with output pixel depth at 16, 24 or 48 bit will not only overcome the past deficiency of indirect digitization of screen-film radiographs. It would also significantly improve the detection of conspicuous lesions in screen film radiographs. The quality of such indirectly digitized images is further improved with SCSI or USB based image transfer from the camera to a faster computer with sufficient RAM and storage space and the use of advanced image processing software for image processing. In the prior art digitization means such as those widely used laser scanner systems do not have such capabilities.

The newer laser and CCD scanners with smaller pixel size give higher resolutions and contrast than those older laser scanners. The laser scanners were thought to be superior to CCD scanners. However the comparative analysis of newer CCD scanners and laser scanners, no significant difference in their performance was reported in a study by Boland, G. W., Shepard, J. O., Trotson-Dickinson, B., Bramson, R. T., Murtada, R. R., and Halpern, E. F., Laser versus Charged Coupled Device (CCD) Digital Scanners: Qualitative Comparison at Differing Comparison Ratios, http://www.rdi-inc.com/scienrep.htm #8. These newer digitizing scanners are presently in clinical use at many major medical centers. However, even these newer scanners do not provide very high resolution of a region of interest that is contained in a digitized image. The resolution of this digitized image is defined for the entire region of the digitized field. It is related to the scanner head's travel to the entire y-axis lines of the digitizing field. Therefore, such scanner resolution is dependent on scanned field size. A larger field size will have larger resolution and a smaller field size will have smaller resolution. For example when a 8×10 inch (203.2 mm×254 mm) screen film is scanned with a most modern high resolution scanner like the Lumiscan 85 with 5120 pixels×6140 lines will give 31,436,800 pixels or 609 pixels per mm. Similarly, a modern CCD scanner like the Howtek Multirad 850 scanner head with 8,000-pixel element and about 5,000 scan lines in the y-axis of scanning of a mammographic film has 8000×5,000 pixels that is 40-million pixel resolution or 775 pixels per mm. This method of scanning of a clinically significant 1×1 inch (25.4×25.4 mm) region of interest in a chest-x-ray however will register only the scan lines representing this 1×1 inch. The y-axis scan lines for this one square inch region of the chest x-ray would be about 62.5. Therefore, the resolution is reduced to 8,000×62.5, that is to 500,000 pixels for the scanned one inch, which is again 775 pixels per mm of the scanned region. If on the other hand a high definition CCD digital camera is used to digitize the screen-film x-ray the total pixel is the same for a full-frame image irrespective of the full-frame or just 1×1-inch region of interest within such an image. If a digital camera like the tri-linear CCD Kaiser Scando Dyn A+with 3648×4,625 pixels is used, the digitized image from a 10×10-inch screen-film x-ray will have 16,872,000 pixels. This total number of pixels will be the same for both the whole 8×10-inch film image or for the 1×1-inch region of interest. In this instance, there are only 327 pixels per mm in the digitized image of the entire film; however there are 26,152 pixels per mm in the 1×1-inch close-up view region of interest. The rapid developments of exchangeable CCD based camera back that can be attached to a conventional camera (U.S. Pat. No. 6,035,147) will make low cost super high resolution easy to operate digital cameras even more feasible. Such developments will make the super high resolution digitized image analysis with a conventional camera that is attached to a super high resolution CCD camera back. The very recently released Better Light Super 8k digital camera has a resolution of up to 8,000×10660 which gives 85,280,000 pixels for a full frame digitized image. Compared to the example given above, the high performance film digitizer laser scan, the Lumiscan 85 with its 31,436,800 pixels, the Better Light Super 8k digital camera's 85,280,000 pixels is 271% higher for the full frame digitized image. The Better Light Super 8k digital camera has 132,184 pixels per mm of 1×1 inch region of digitized image as compared to the laser scanner, Lumiscan 85's 609 pixels per mm in the 1×1 inch region of interest. It is an increase of 217,051% in favor of the Better light Super 8k digital camera. A 1×1 inch (2.54×2.54 cm) region of interest in a screen film chest x-ray could contain an ill defined and difficult to recognize a few mm to less than a cm sized early stage T₁ (less than 2 cm) lung cancer. Missing such a tumor will deprive the chances for cure of this very early stage lung cancer. The digitized analysis of such a region in a screen film chest x-ray with a super high CCD digital camera can facilitate the diagnosis and treatment of such very early stage lung cancer. Smaller the pixels, higher the contrast. Therefore, digitization of a screen film chest x-ray with super high-resolution CCD digital camera could increase the pixels over 130,000 per mm. It could greatly improve the spatial resolution and thereby the detection of very small microcalcifications and other tumor associated early changes.

In a screen film chest x-ray there are many latent information present, but not recognized because of its decreased signal to noise ratio associated poor spatial resolution. In an image there are the desirable information, the signal and the undesirable information the noise. If there is much undesirable noise, then the desirable information gets clouded with the noise. The small grains of film emulsion causes increased noise. This noise combined with the blur caused by the screens in the screen film chest x-ray reduces its spatial resolution. It makes the detection of very small structures difficult. Therefore, digitization of a screen film chest x-rays with super high-resolution CCD digital camera could increase the pixels over 130,000 per mm. It could greatly improve the spatial resolution and thereby the detection of very small tumor and the tumor associated early changes. For high pixel resolution regional cropped up image analysis of an area with a suspected lesion, the high and super high resolution digitized image captured with a high and super high resolution CCD camera is much superior than a cropped up image that was digitized with a laser or a CCD scanner.

The digitized image can be incorporated to the Picture Archival and Communication System (PACS) of a radiology department for the side by side image display of the original x-ray images and its digitized image for diagnostic readings. The digitized image can also be used in teleradiology systems.

The close-up view digital macroscopy with high-resolution digital camera will give very high pixel sized digital image of a selected region. It is because the number of pixels in a digitized image is not dependent on the size of the image as when images are scanned for digitization like with a laser or a CCD scanner. The number of pixels in a scanned image is dependent upon the x-y axis of the scanned region. Lesser the height of the scanned region, there will be lesser the number of pixels in the digitized image. Since the digitized image captured with a digital camera is not dependent on this principle, the entire pixel resolution of the camera will be present in the digitized image of a smaller macroscopic region. If the camera has two million or 20 million pixel capability, the digitized image will have this many pixels irrespective of whether the image that was captured from a smaller region or from a larger region. This facilitates capture of high-resolution magnified image from a region in a screen film chest x-ray with a high-resolution digital camera. If the system can display the adjacent objects at different contrasts, then they can be recognized as separate ones, otherwise they will appear as a single object. Such image processing can overcome the limitations of the screen-film chest x-ray's resolution and it will facilitate better visualization of the smaller structures in the chest x-ray.

The digitized capture of a region containing a suspicious lesion from a screen film chest x-ray with a high resolution and high intensity digital camera with a zoom lens further allows the digitized and close-up view magnified analysis of such lesions, namely by digital macroscopic chest x-ray. Digital tissue sections can further process the digital images. By selecting the appropriate lens for the digital camera, the whole or a portion of the chest x-ray could be digitized and used as directly magnified image than by electronically magnified image. In the electronically magnified image, the noise introduced by the magnification will reduce the spatial resolution of the structures.

In general, the digitized image's software assisted computer analysis allows its electronic magnification, rotation, tonescale and histogram analysis, masking, sharpening and filtration. Such electronic analysis of the digitized image enhances the visibility of the otherwise unobvious but diagnostically significant elements in a chest x-ray. It also provides an easier means of storage and distribution for distant consultation. The analysis of the digitized image at different window levels allows bringing the optical density of the digitized image to a wide range to compensate the wide range of exposures used in image acquisition chest x-rays. Due to variations in patient's size, differences in its tissue composition, the variations in exposure, KVP chemical processing the optical density of the screen film chest x-ray could vary significantly. The digitized screen-film chest x-ray's window adjustment can eliminate such variations in its optical density. Such window adjustment allows bringing the desired display luminance that is the optical density of a digitized image. This makes it easier to visualize a conspicuousness of a lesion in a screen film chest x-ray.

### Objects and Advantages

Accordingly, several objects and advantages of my invention are to provide a cost efficient system consisting of high resolution digital or analog cameras, digital line scanning cameras or view cameras with CCD camera back and image processing by means of commonly available computers and image processing software and its side by side display with the original chest x-rays, for a second reading to improve the diagnostic sensitivity of such medical images to make early diagnosis of pulmonary diseases including very early stage evolving lung cancer, pneumoconiosis and pulmonary interstitial diseases.

It is another object of this invention to facilitate the practical utilization of the theoretical spatial resolution of the film used in screen-film radiographs by its digitized and contrast enhanced image analysis with modern larger CCD digital cameras with high input and output resolutions and contrast enhancement for the detection of latent structures from screen film radiographs by suppression of interference from contrast of two adjacent structures to enable the early detection changes associated with lung diseases especially of lung cancer.

It is a further object of this invention to improve the ability to detect the very small diagnostically important changes contained in a chest x-ray that are very difficult to recognize by conventional means by side by side comparative readings of the original such source images and their improved high resolution digitized and software assisted processed image as a second reading to improve the diagnostic sensitivity of chest x-rays and classification of benign and malignant lung diseases.

It is another object of this invention to convert the analog image signal captured by analog cameras and to convert and save it as digital image by means of a frame grabber for side by side comparative readings of the original source images and the digitized and software assisted processed images as a second reading to improve the diagnostic sensitivity of such images and classification of benign and malignant lung diseases.

It is a further object of this invention to minimize the noise and to improve the contrast, brightness and optical density in the digitized image of a chest x-ray, by high resolution image capture with high resolution digital cameras with pixels of about 1,652 per mm and higher for the whole of the chest x-ray and up to about 132,000 pixels per mm for a region of interest than the present methods of digitized image capture with 600 to 775 pixels per mm with high definition laser or CCD scanning film digitizers.

It is another object of this invention to minimize the noise and to improve the contrast, brightness and optical density in the digitized image of a region of interest in a chest x-ray by high resolution image capture with high resolution digital cameras with pixels ranging from 2976 to 132,184 per mm.

It is another object of this invention to minimize the noise and to improve the spatial resolution, contrast, brightness and optical density in the digitized image of a region of interest in a chest x-ray by image capture with high resolution digital cameras with pixels ranging from 2976 to 132,184 per mm than by electronic magnification of a region of interest in a digitized image captured with 600 to 775 pixels per mm with high definition laser or CCD scanning film digitizers with the resultant increased noise and decreased contrast, brightness and optical density.

It is a further object of this invention to analyze high and super high resolution digitized cropped up image of a region of interest with high and super high pixels resolution by CCD digital camera based indirectly digitized image capture and to review such high resolution cropped up image in a computer's monitor or as a full size print and to overcome the disadvantages associated with the low pixels resolution of a cropped up digitized image captured with a laser or a CCD scanner.

It is yet another object of this invention to digitize the chest x-rays, with low cost high-resolution CCD digital cameras as an alternative to the costlier laser and CCD film digitizing scanners for the digitized image analysis of chest x-ray, chest CT and MRI or of a small region of interest in such images with much higher resolution, contrast and brightness than that is achievable with high definition laser and CCD film digitizers.

It is a further object of this invention to capture direct digital image by means of high resolution digital cameras or high resolution line scanning digital cameras and to save them in varying file format for side by side comparative readings of the original source images and their improved high resolution digitized and or software assisted processed image as a second reading to improve the diagnostic sensitivity of such images and classification of benign and malignant diseases.

It is another object of this invention to use different window levels to bring the optical density of the digitized image to a wide range to compensate the differences in optical density of screen film radiographs due to wide range of exposures used in image acquisition, patient's sizes, differences in tissue composition of the lung tissue and chemical processing of screen film radiographs to achieve desired display luminance that is the optical density to show conspicuousness of a lesion in the lung and to make it easier to see.

It is yet a further object of this invention to process the digitized medical images of a patient by sizing and orientation, copy and paste, palette and pixel analysis, convolution, edge detection and modification, pixel and pair arithmetic, binning, contrast modification, histogram analysis, morphology dilation and erosion, skeletons and thinning, pair normalization, sequence averaging and sequence difference and side by side comparative readings of the original source chest x-rays, and its processed image for a second reading to improve the diagnostic sensitivity of such images and classification of benign and malignant lung diseases.

It is a further object of this invention to use the improved digitized chest x-rays for pixel analysis, arithmetic processing, contrast modification and contrast inversion, noise filtering, convolution, edge detection, spatial processing, image sequence analysis, image intensity and spatial calibration, measurement of histograms, mass and moments, line profile and shape, segmentation, subpixel edger, and to introduce graphics and texts with the aid of image processing software and its side by side comparative readings to improve the diagnostic sensitivity of such images and classification of benign and malignant lung diseases.

It is another object of this invention to view the high resolution digitized images of chest x-rays at its full size by scrolling the image or the whole image in a monitor attached to a computer by percent reduction of the image file size and to review the digitized images side by side with original source images as a second reading to improve the diagnostic sensitivity of the chest x-rays for classification of benign and malignant lung diseases.

It is a further object of this invention to view the percent reduced full sized digitized image by its projection on to a screen with the aid of an electronic projector attached to a computer and review of the digitized images side by side with original source images as a second reading to improve the diagnostic sensitivity of the chest x-rays for classification of benign and malignant diseases.

It is yet another object of this invention to print the digitized processed image for record keeping as a low cost permanent record of a patient's chest x-rays in a patient's medical record chart.

It is a further object of this invention to improve the early detection of diagnostically important medical information contained in the medical imaging that are recorded onto hard copy recording medium such as those of chest x-rays by the digitized contrast and tonescale enhanced image analysis for side by side comparative readings with the original source images as a second reading to improve the diagnostic sensitivity of such images and classification of benign and malignant lung diseases.

It is a further object of this invention to improve the detection of diagnostically important information contained in the digital output of a diagnostic device by capture and storage of the digital image onto a recording medium and its subsequent contrast and tonescale enhanced analysis with image processing software for cost efficient image analysis for the diagnosis and treatment of lung diseases.

It is another object of this invention to facilitate the practical utilization of the theoretical spatial resolution of the film used in screen-film chest x-rays by its digitized and contrast enhanced image analysis with modern larger CCD digital cameras with high input and output resolutions and contrast enhancement under software control for the theoretically possible detection of the latent early changes associated with lung diseases especially of lung cancer without interference from adjacent structure's contrast interference.

It is another object of this invention to improve the detection of the difficult to detect hilar and mediastinal lymph node diseases particularly of lymph nodes associated with lung cancer by means of side by side comparative readings of the original source images and their improved high resolution digitized and software assisted image analysis as a second reading to aid the diagnostic sensitivity of chest x-rays to detect hilar and mediastinal lymph nodes.

It is a further object of this invention to improve the early detection of silicosis and coal worker's pneumoconiosis, asbestosis, hard metal lung disease such as those due to beryllium, and cobalt, interstitial lung disease with granulomas seen in a patient's screen film chest x-rays scans recorded onto films or to other hard copy recording medium by side by side comparative readings of the original source images and their improved high resolution digitized and software assisted image analysis as a second reading to aid the diagnostic sensitivity and classification of early pulmonary silicosis and coal worker's pneumoconiosis and their treatment and surveillance.

It is still another object of this invention to improve the sensitivity of the chest x-rays and chest CT scans by side by side comparative readings of the original source images and digitized images by improved high resolution digitized and software assisted image analysis as a second reading to identify the rounded atelectasis with comet tail or curvilinear shadows that extend from the periphery towards the hilum and its differential diagnosis from bronchogenic carcinoma.

It is a further object of this invention to improve the sensitivity of the CT and MRI scans by side by side comparative readings of the original source screen film chest x-rays, chest CT or MRI scans that are recorded onto films or to other medium and their improved high resolution digitized and software assisted image analysis as a second reading to improve the visualization of pulmonary changes that are associated with sarcoidosis that are seen in the chest x-rays, Chest CT and MRI for the early diagnosis and treatment of pulmonary sarcoidosis.

Still further objects and advantages will become apparent from a consideration of the ensuing description and accompanying drawings.

### BRIEF DESCRIPTION OF THE DRAWINGS

FIG. 1: High Resolution Image Capture and Processing System with DICOM Compliance Archive.

FIG. 2: High Resolution Image Capture and Processing System without Image Conversion as DICOM Compliance Archive.

FIG. 3A: Image Digitizing, Processing and DICOM Compliance Sections

FIG. 3B: CCD high-resolution digital microscope camera 28 Directed Towards a Wall Mounted Illumination Section 10

FIG. 3C and FIG. 3D: CCD High-Resolution Interchangeable Single Lens Reflex Digital Camera 54

FIG. 3E: Ultra High-Resolution CCD Scanning Digital Camera Back 64 Fitted onto a Standard 4″×5″ View Camera 66

FIG. 4: Section for Digital Image Signal Processing with a Computer and Image-Processing Algorithm 14

FIG. 5: Section with a Server, Workstations, Display Units and Printers 20

FIG. 6: Section with Removable Disc Storage Devices 22

FIG. 7: Integrated System for High Intensity Digitized Macroscopic Digitized Tissue Layer Sectional Analysis

FIG. 8: Examples of Tone Curves that are used for Digital Tissue Sectioning

FIG. 9 Indirect Digital Image Acquisition and Image Processing with Low Cost Digital Camera, TV camera with a Frame Grabber or with Scanners

FIG. 10-A is a reduced sized print of a digitized chest x-ray of a patient taken in 1995. There was an evolving mass located close to the mediastinum. This mass could not be read from its undigitized original chest x-ray of 1995.

FIG. 10-B is a reduced sized print of the close up view digitized image captured from the region of the evolving mass that was located as close to the mediastinum as shown in FIG. 10-A, 1995 digitized chest x-ray. This mass could not be read from its undigitized original chest x-ray of 1995.

FIG. 10-C is a reduced sized print of a digitized 1996 chest x-ray of the same patient whose chest x-ray taken a year ago and is illustrated in FIG. 10-A and FIG. 10-B. There is an evolving mass with tumor angiogenesis located close to the mediastinum. This mass could not be read from its undigitized original chest x-ray of 1996.

FIG. 10-D is a reduced sized print of the close up view digitized image captured from the region of the evolving mass shown in FIG. 10-C, 1996 chest x-ray. This mass could not be read from its undigitized original chest x-ray of 1996.

FIG. 10-E is a reduced sized print of a digitized 1998 chest x-ray of the same patient whose chest x-ray taken in 1995 and 1996 are illustrated in FIG. 10-A, FIG. 10-B and in 1996, FIG. 10-C and FIG. 10-D. There is an evolving mass located close to the mediastinum. This mass could not be read from its undigitized original chest x-ray of 1998.

FIG. 10-F is a reduced sized print of the close up view digitized image captured from the region of the evolving mass shown in FIG. 10-E, 1998 chest x-ray. This mass could not be read from its undigitized original chest x-ray.

FIG. 10-G is a reduced sized print of a digitized 1999 chest x-ray of the same patient whose digitized chest x-ray's prints of 1995, 1996 and 1998 are shown in FIGS. 10-A and 10-B, 1995, in FIGS. 10-C and 10-D, 1996 and in FIGS. 10-E and 10-F, 1998. A tumor located in the right upper lobe, close to the mediastinum became now obvious and it was read from its undigitized original chest x-ray.

FIG. 10-H is a reduced sized print of the close up view digitized image captured from the region of the reported tumor mass shown in FIG. 10-G, 1999 chest x-ray.

FIG. 10-I is a reduced sized print of the digitized and processed 1999 chest x-ray as in FIG. 10-G but treated with a different tone cure to demonstrate the advanced stage of the tumor, stage T₃ due to tumor invasion to both visceral and mediastinal pleura.

FIG. 10-J is a reduced sized print of the digitized and processed close up view 1999 chest x-ray as in FIG. 10-H but treated with a different tone cure for a closer observation of this advanced stage, stage T₃ tumor with tumor invasion to both visceral and mediastinal pleura.

FIG. 11-A is a reduced sized print of a high-resolution digitized chest x-ray of a patient with early stage pneumoconiosis and a suspicious mass in the lung requiring the differential diagnosis of a malignant growth or a developing pneumoconiotic mass.

FIG. 11-B is a reduced sized print of a 8-bit gray scale image converted from the digitized image shown in FIG. 11A. It was further treated by left-shift arithmetic processing for enhanced visualization of the diffuse early stage pneumoconiotic changes in the lung and the organs of the lung.

FIG. 11-C is a reduced sized print of an 8-bit gray scale image converted from the digitized image shown in FIG. 11A. It was further treated by tone curve 150-B for comparison with left shift arithmetic processing shown in FIG. 11-B for enhanced visualization of the diffuse early stage pneumoconiotic changes in the lung and the organs of the chest.

FIG. 11-D is a comparative reduced sized print of a 8-bit grayscale digitized and left shift arithmetic processed chest x-ray print as the FIG. 11-B of an elderly patient with behind the heart pulmonary metastasis and no pneumoconiosis.

FIG. 11-E is a cropped up image prepared from the digitized chest x-ray print shown in FIG. 11-D with a right lower lobe pulmonary metastasis to illustrate the finer details of the metastatic tumor.

FIG. 11-F is a print of the cropped up digitized image captured from a six months earlier chest x-ray of the same patient whose six months later digitized cropped up chest x-ray print with pulmonary metastasis is shown in

FIG. 11-E. It illustrates the presence of a tumor nodule in this earlier digitized chest x-ray but its original undigitized chest x-ray was read as negative for metastatic disease.

FIG. 11-G is a one and half times magnified print of the same digitized cropped up image illustrated in FIG. 11-F but after treatment with tone curve 150-B.

FIG. 12A is a 20 percent reduced sized print of a 48-bit digitized grayscale image of a chest x-ray of a patient with pulmonary sarcoidosis after it was treated with tone curve 150-B.

FIG. 12-B is a full sized print of the cropped up portion of the digitized chest x-ray image shown in FIG. 12-A to illustrate the grossly enlarged hilar mediastinal lymph nodes of sarcoidosis and to aid for its differential diagnosis from metastatic lymph nodes.

### REFERENCE NUMERALS

10 illumination section

12 image digitizing section

14 section for digital image signal processing with a computer and image processing algorithms

16 image processing algorithms

18 section for processed image conversion as DICOM compliance archive

20 section with a server, workstations, display units and printers

22 section with removable disc storage devices

24 even lighted x-ray trans-illumination light box

26 film-holder and light field adjustment device

28 CCD high-resolution digital microscope camera

30 high-resolution digital camera

32 camera scanner

34 interchangeable lens

36 camera stand

38 column of the camera stand

40 spring loaded camera attachment device

42 screwing device

44 camera stand locking screw

46 vertical distance marker

48 base

49 electrical power inlets and outlets

50 screws

52 SCSI interface connections

53 wall

54 CCD high resolution interchangeable single lens reflex digital camera

56 tripod

58 LCD image view finder

60 reflex camera's storage medium

62 USB digital interface

64 ultra high-resolution CCD scanning digital camera back

66 view camera

68 computer's SCSI connection port

69 computer system

70 communication infrastructure

72 processor

74 main memory

76 display interface

78 display

80 secondary memory

82 hard disk drive

84 removable storage drive

86 interface

88 removable storage unit A

90 removable storage unit B

92 communications interface

94 communication path

96 server

98 Ethernet connections

100 hub

102 workstations

104 monitors

106 printers

108 removable storage discs

110 LCD projector

112 floppy disc

114 PC card

116 Smart Media card

118 Zip disc

120 Jazz disc

122 CD-R

124 MO disc

125 SSCI interface

126 external removable high volume storage drives E

128 external removable high volume storage drives F

130 external removable high volume storage drives G

132 low cost digital camera

134 TV camera camcorder

136 camcorder's video tape

138 interfacing frame grabber

144 PC or Macintosh computer

146 desktop

148 camera cabinet

150-A mediastinum tone curve A

150-B mediastinum tone curve B

152 marked color enhanced region

154 tumor nodule

156 chest wall

158 lung

160 heart

162 mediastinum

164 close up view, color enhanced region

165 magnified ill-defined tumor mass with irregular boarders

166 1996 chest x-ray's marked color enhanced region

168 larger than 1996 tumor nodule

169 tumor blood vessel

170 1996 close up view color enhanced region

172 ill-defined solid tumor mass with irregular tumor boarders

174 1998 chest x-ray's marked color enhanced region

176 larger than 1996 tumor mass

178 1998 close up view color enhanced region

180 ill-defined larger solid mass with irregular boarders

182 1999 chest x-ray's marked color enhanced region

184 still larger than 1998 tumor mass

186 1999 close up view color enhanced region

188 ill-defined much larger squamous cell carcinoma

190 visceral pleura

191 tumor invading visceral pleura

192 mediastinal pleura

193 tumor invading mediastinal pleura

194 pericardium

196 tumor

198 tumor invasion to visceral pleura

200 tumor invasion to mediastinal pleura

202 circumscribed pneumoconiotic opacity

204 pneumoconiosis associated hilar lymphadenopathy

206 diffuse large aggregates of pinhead sized opacities

208 denser pneumoconiotic deposits

210 parietal pleura

212 ribs

214 vertebrae

216 diaphragm

218 ill-defined pneumoconiotic opacity

220 metastatic nodules

222 left ventricle

224 pulmonary metastatic tumor

226 behind the heart pulmonary metastasis 1

228 behind the heart pulmonary metastasis 2

230 encircled September 1999 right lower lobe metastasis

232 visceral pleura with metastatic tumor

234 mediastinal pleura with metastatic tumor

236 March 99 undiagnosed right lower lobe metastasis

238 encircled March 99 unread right lower lobe metastatic tumor

240 enlarged hilar mediastinal lymph nodes of sarcoidosis

242 mediastinal pleura without tumor invasion

### SUMMARY

This invention relates to methods of improved high-resolution digitized, tone curves and colors adjustments assisted digital image analysis as comparative double reading of chest x-rays to minimize the overlook of diagnostically important information contained in the chest x-rays. It enables the detection of tumors years earlier than they become visible in the routine chest x-rays. It allows suppression of contrast and brightness interference from lesser density structures and display of higher density structures with higher contrast and resolution. Such digitized image analysis of yearly chest x-rays of patients who were found to have lung cancer shows that the lung cancer is a very slowly developing disease. Before a tumor becomes visible in a chest x-ray, it is present in the lung for many years. Recognition of such very early stage tumors will significantly improve the treatments and cure rate of lung cancer. The digitized chest x-ray processed with arithmetic left shift helps to define the extent of early developing pneumoconiosis, visualization of visceral and parietal pleura and the pericardium and the diseases involving such structures. This digitized image analysis system comprises of high resolution larger and super CCD digital cameras (30), image processing algorithms, means for image storage (82,84), display monitor (104), networking server (96) with Ethernet interface (100), viewing workstations (98), LCD projector (106) and printers (108). The spatial resolution of this CCD camera based system is superior to indirect film digitization by laser and CCD scanners.

### Preferred Embodiment—Description

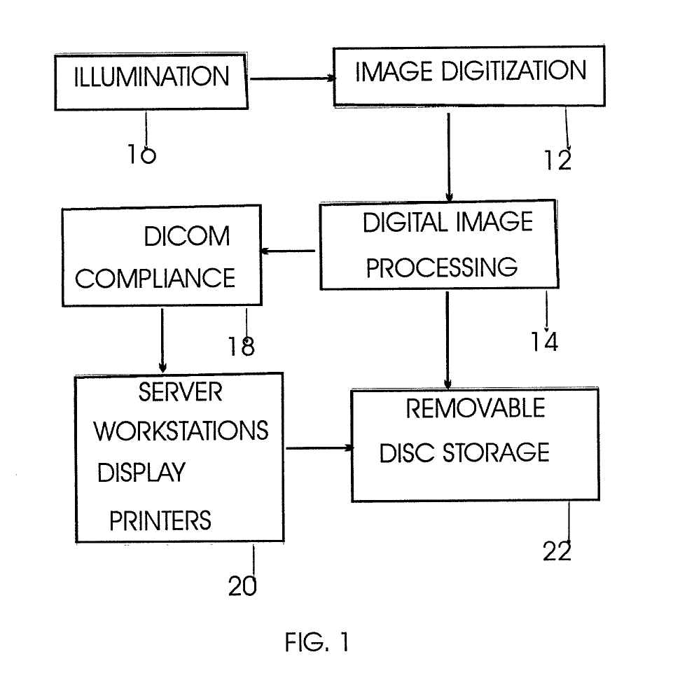

FIG. 1: High Resolution Image Capture and Processing System with DICOM Compliance Archive.

FIG. 1 illustrates a typical system in which the present invention could be practiced. It consists of an illumination section 10 for illumination of a image, a image digitizing section 12 with CCD high-resolution, super high-resolution or ultra high-resolution digital camera by which the digital image signal from the radiographic image is generated, a section for digital image processing with a computer and image processing algorithms 14 in which the acquired digital image signal is processed by image processing algorithms 16 to improve the image quality for improved visualization of diagnostically important structures, a section for processed image conversion as DICOM compliance archive 18, a section with a server, workstations, display units and printers 20 and a section with removable disc storage devices 22 that are connected to the section for digital image processing with a computer and image processing algorithms 16 or to the workstations as a second means for digitized image storage and archive.

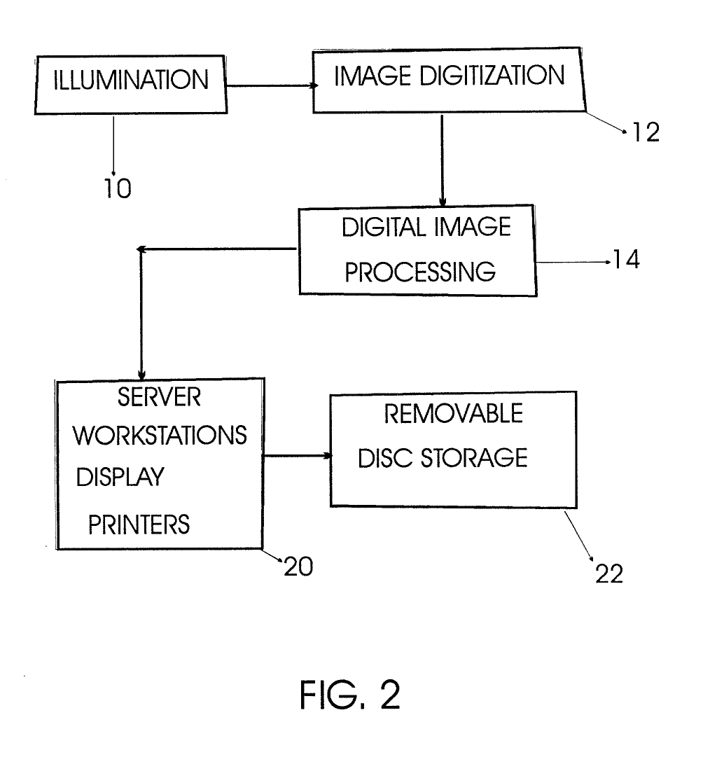

FIG. 2: High Resolution Image Capture and Processing System without Image Conversion as DICOM Compliance Archive.

FIG. 2 The image acquisition and processing system in FIG. 2 is as it is in FIG. 1 except it contains no section for processed image conversion as DICOM compliance archive 18. This invention can operate without the section for processed image conversion as DICOM compliance archive 18.

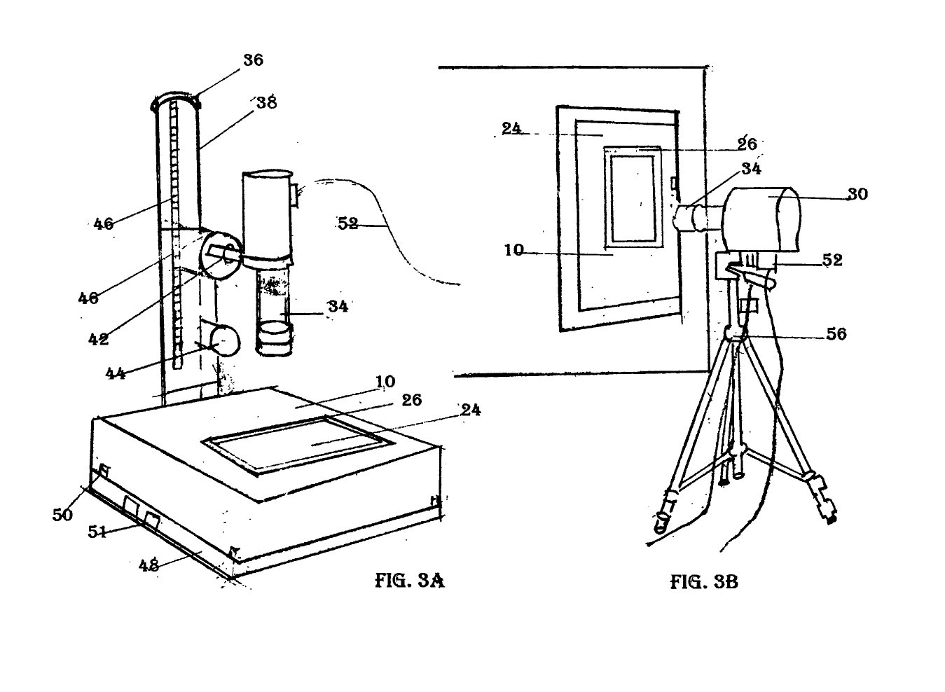

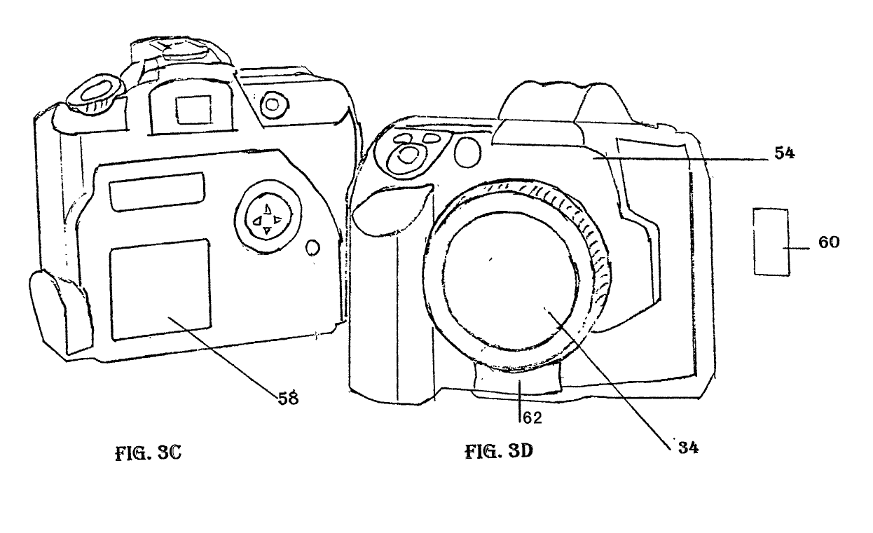

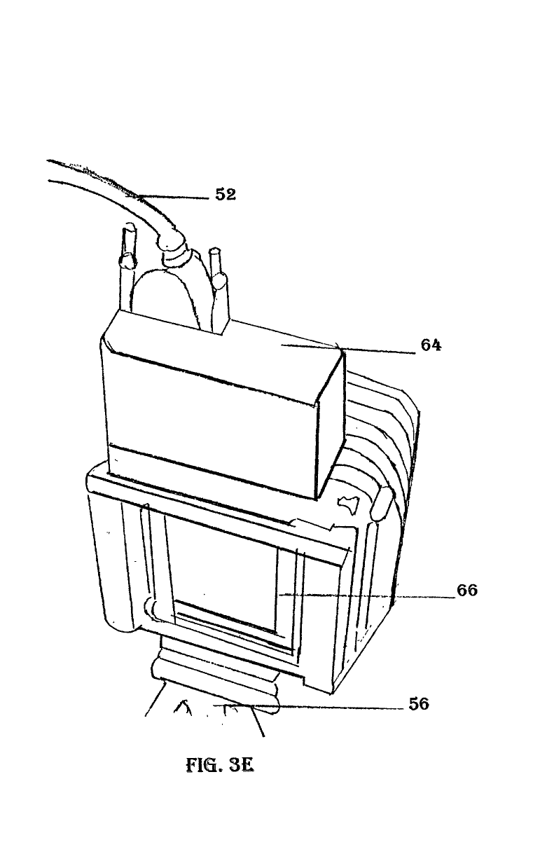

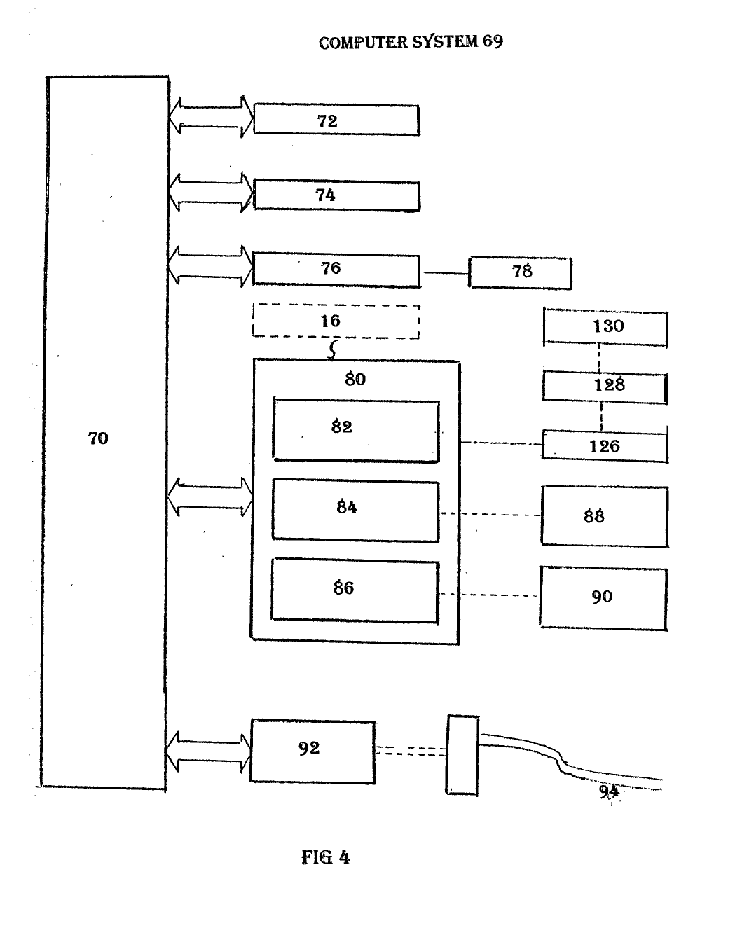

FIG. 3-A: Image Digitizing, Processing and DICOM Compliance Sections

FIG. 3-A illustrates the image digitizing section 12 of this invention. It consists of an interchangeable CCD high-resolution digital microscope camera 28 or a high-resolution digital camera 30 or a camera scanner 32 or a CCD high-resolution interchangeable single lens reflex digital camera 54 or a super high-resolution CCD digital scanning camera back 64 fitted onto a view camera 66. Examples of such high-resolution digital camera 30 and camera scanner 32 include the Fujifilm's FinePix S1 Pro Super CCD, the Polaroid DMC le digital microscope camera, the Kaiser Scando Dyna A+camera scanner and similar rapidly developing high and super high resolution digital cameras. The newer Fujifilm's FinePix S1 Pro Super CCD digital camera with pixels positioned at 45° angle gives much increased sensitivity, signal/noise ratio and dynamic range. Its 23.3×15.6 mm super CCD sensor and image file sizes of 3,040×2016/2,304×1,536 and 1,440×960 pixels are of distinct advantages over the conventional CCD digital cameras. At image file size of 3,040×2016 pixels and 24 bit or 48 bit RGB settings, it has an image file size of 17.5 and 35 MB respectively. The Polaroid DMC le Digital Microscope Camera captures image at 12-bit linear RGB at resolutions of 1600×1200, 800×600 and 400×300 with its 12.15 megapixiel CCD. At its super high resolution of 1600×1200, the file size at 8 bit, 16 bit, 24 bit and 48 bit image are 1.92, 3.84, 5.76 and 11.52 MB respectively. The camera scanner like the Kaiser Scando Dyna A+ camera scanner captures images at 3,648×4,625 pixel resolution. Small area of region of interest, like that for the digital macroscopic region of interest in an image is scanned with very high resolution by such digital cameras than by high-resolution flatbed CCD scanners or by the high-resolution laser scanners. Any rapidly developing high and super-high resolution CCD digital cameras can be used for this invention.

The high-resolution digital camera 30 is attached to a camera stand 36. An interchangeable lens 34 is attached to the camera. Column of the camera stand 38 is fitted with a spring-loaded camera attachment device 40 to which the camera is fitted with a screwing device 42. The spring-loaded camera attachment device 40 can travel up or down on the column 38 of the camera stand 36. At a desired position on the column 38 of the camera stand 36, the spring loaded camera attachment device 40 is locked with a camera stand locking screw 44. The vertical distance marker 46 on the column of the camera stand 38 allows the readings of the focal length between the camera and the digitizing image fixed onto the even lighted x-ray trans-illumination light box 24. The digitizing image is placed in position the film-holder and light field adjustment device 26. The even lighted x-ray trans-illumination light box 24 of illumination section 10 is fixed on of the base 48 of the camera stand 38 with screws 50. The base 48 is equipped with electrical power inlets 49 and outlets. The high-resolution digital camera 30 is connected to the power outlet of the base 48 of the camera stand 36. Through USB digital interface 62 or SCSI interface connections 52, the High-resolution digital camera 30 is connected to the section for digital image processing with a computer and image processing algorithms 14 and to the section with removable disc storage devices 22.

FIG. 3-B: CCD High-Resolution Digital Microscope Camera 28 Directed Towards a Wall Mounted Illumination Section 10

Alternatively, the high-resolution digital camera 30 is directed towards a wall 53 mounted illumination section 10 with the even lighted x-ray trans-illumination light box 24 and film-holder and light field adjustment device 26. In this instance the camera is held in position with a tripod 56.

FIG. 3-C and FIG. 3D: CCD High-Resolution Interchangeable Single Lens Reflex Digital Camera 54

FIG. 3C and FIG. 3D illustrates the alternative CCD high-resolution interchangeable single lens reflex digital camera 54. FIG. 3C is the front view and FIG. D is the back view of the CCD high-resolution interchangeable single lens reflex digital camera 54. It can capture image files ranging from 1.3 to 6 million pixels. Many such commercial products are available. Examples of such professional class digital camera include the Nikon E2N & E2Ns with 1.3 megapixel CCD, Canon EOS with 3 megapixel, Kodak DCS 330 with 3.3 megapixel, Kodak DCS 460, 560, 660, Canon/Kodak EOS DCS 1 and Fujifilm super CCD FinePix S1 PRO with about 6 megapixel. This is a rapidly developing field and soon such digital cameras with more megapixel would become available. Newer developments also include digital cameras with exchangeable CCD digital camera back. Like before, this camera is attached to the camera stand 36. The interchangeable lens 34 is attached to the camera through its appropriate C- or F-mount. The LCD image viewfinder 58 of the camera allows the preview of the image for focusing and image corrections before its capture as single frame and storage onto a reflex camera's storage medium 60. Such storage media includes Smart Media Card or Compact Flash Card type II. The digital interface of the captured image is done by USB digital interface 62. The image files are stored in the computer's hard disk drive 82 or to the external removable discs, 126-130 or by transfer of the reflex camera's storage medium 60 to the computer.

Alternatively, in a similar arrangement as shown in FIG. 3B, the CCD high-resolution interchangeable single lens reflex digital camera 54 is mounted on a tripod 56 and directed towards a wall 53 mounted illumination section 10 with the even lighted x-ray trans-illumination light box 24 and film-holder and light field adjustment device 26. The digitized image is stored in reflex camera's storage medium 60 and transferred and processed in the computer with image processing algorithm 16.

FIG. 3E: Ultra High-Resolution CCD Scanning Digital Camera Back 64 Fitted onto a Standard 4″×5″ View Camera 66

FIG. 3E illustrates another alternative device for ultra high-resolution image acquisition. In this instance, an ultra high-resolution CCD scanning digital camera back 64 is fitted onto a standard 4″×5″ view camera 66. By attaching the ultra high-resolution CCD scanning digital camera back 64 to a view camera 66, ultra high-resolution digital images are captured. With stronger supporting means, the ultra high-resolution CCD scanning digital camera back 64 fitted onto a standard 4″×5″ view camera 66 is attached to the camera stand. Examples of such digital camera back inserts include the Phase One digital camera back, the Better Light's digital camera back, the Triple-Shot T32 professional digital camera and similar products. The Phase one digital camera back when fitted to a view camera 66 captures 108 million color pixels. Similarly, the better Light's camera back with a view camera 66 captures images at 42 bits depth and at ultra high-resolution images of 8,000×10,0660 pixels or over 85 million pixels. The Mega Vision's Triple-Shot T32 professional digital camera can capture 16 bit, about 6 million-pixel resolution images. The view camera 66 with an ultra high-resolution CCD scanning digital camera back 64 is fitted onto the camera stand 36. The camera is connected to an IBM PC computer by USB serial port connection 51 or SCSI connection 52. The camera is connected to the computer through the computer's SCSI connection port 68.

Alternatively, in a similar arrangement as in FIG. 3B, the ultra high-resolution CCD scanning digital camera back 64 fitted onto a standard 4″×5″ view camera 66 is mounted on a tripod 56 and directed towards a wall 53 on which the illumination section 10 is mounted. A stronger tripod is selected to hold the ultra high-resolution CCD scanning digital camera back 64 fitted onto a standard 4″×5″ view camera 66. The illumination section 10 contains the even lighted x-ray trans-illumination light box 24 and film-holder and light field adjustment device 26. The camera is connected to an IBM PC computer by its SCSI connection 52 or USB digital interface 62. The camera is connected to the computer through the computer's SCSI connection port 68. The digital image signal processing of the digitized captured image is done in section 14 with a computer system 69 and image processing algorithms 16

FIG. 4: Section for Digital Image Signal Processing with a Computer and Image-Processing Algorithm 14

FIG. 4 illustrates the section for digital image signal processing with a computer and image-processing algorithm 14. The digital image signal processing of the digitized captured image is done in this section. The dry lab image processing of the captured image signal is done with image processing algorithms 16. Computer system 69 consists of communication infrastructure 70, processor 72, main memory 74, display interface 76, display 78, secondary memory 80, hard disk drive 82, removable storage drive 84, interface 86, removable storage unit A 88, removable storage unit B 90, communications interface 92, communication path 94. Optionally, the computer system 69 is connected through SCSI connections to external removable high volume storage drives E 126, external removable high volume storage drives F 128 or external removable high volume storage drives G 130 for removable disc storage for manual distant transportation as “store and forward”. The processed image is then transferred to the section for processed image conversion as DICOM compliance archive 18 with DICOM software.

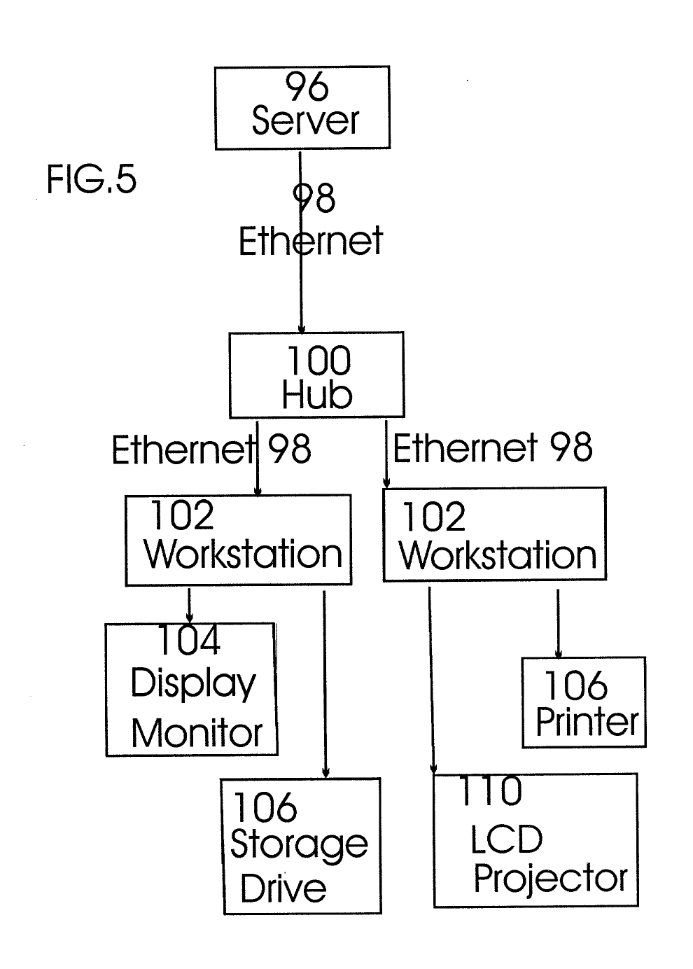

FIG. 5: Section with a Server, Workstations, Display Units and Printers 20

FIG. 5 shows the section with a server, workstations, display units and printers 20 for image storage, processing, recall, and its display on monitors or as prints. A server 96 is used for image storage, processing and recall. Ethernet connections 98 and hub 100 connects the server 96 to workstations 102. The images are viewed on the monitors at workstations 102 or on display monitors 104 attached to it. Alternatively, the image is projected onto a screen with a LCD projector 110. Hard copy images are printed with printers 106. The images are also stored onto any one of the group from removable storage discs 108 such as a floppy disc 112, a PC card 114, a SmartMedia card 116, a Zip disc 118, a Jazz disc 120, CD-R 122, or a MO disc 124 by means of removable storage drive 84, removable storage unit A 88, removable storage unit B 90, through SCSI connected external removable high volume storage drive E 126, external removable high volume storage drive F 128 or external removable high volume storage drive G 130.

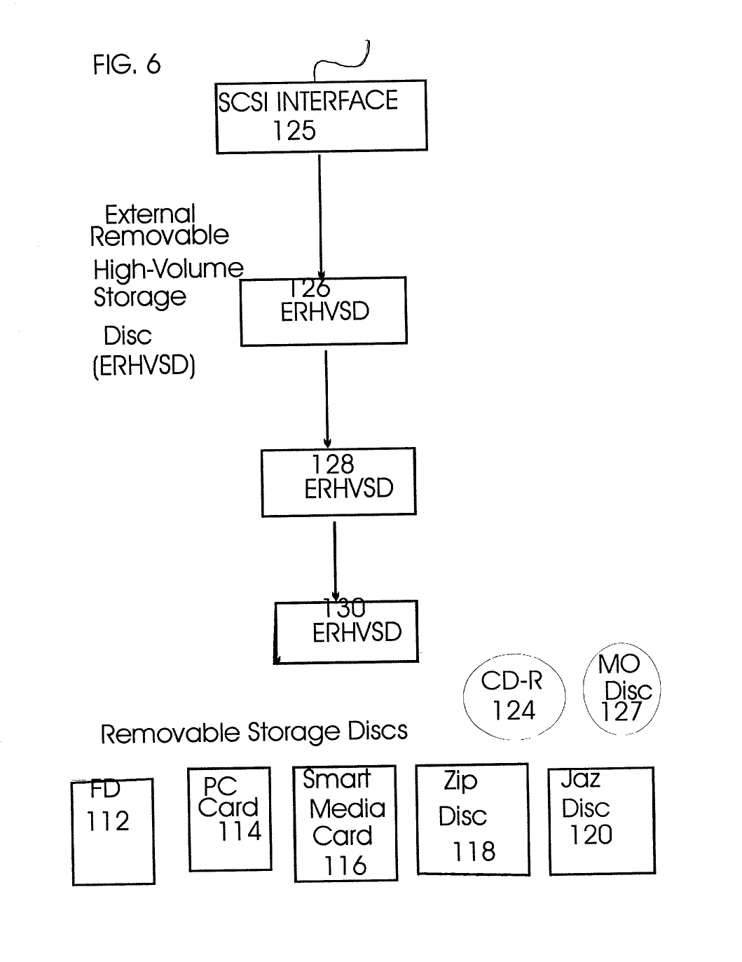

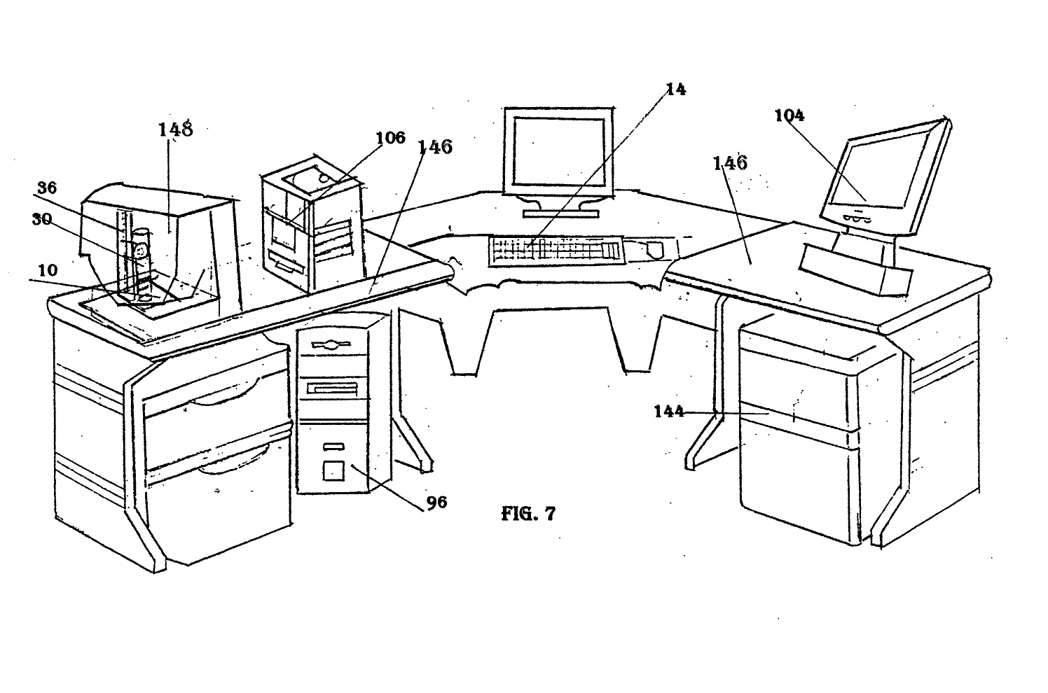

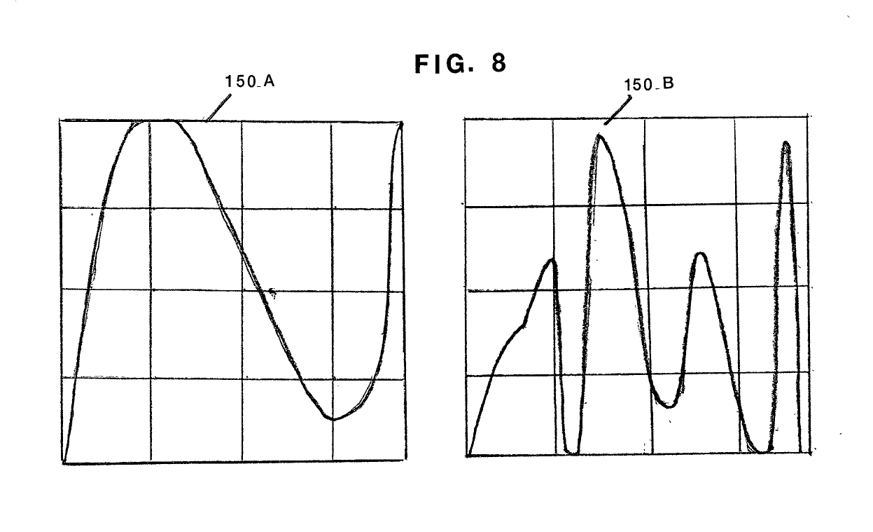

FIG. 6: Section with Removable Disc Storage Devices 22

FIG. 6 shows the section with removable disc storage devices 22. Through SCSI interface 125, external removable high volume storage drives (ERHVSD) are connected to a PC or Macintosh computer 144. Such external removable high volume storage drives 126, 128 and 130 are used for image storage onto removable storage discs. Such removable storage disc group consists of the floppy disc 112, the PC card 114, the SmartMedia card 116, the Zip disc 118, the Jazz disc 120, the CD-R 122, or the MO disc 124.

FIG. 7: Integrated System for High Intensity Digitized Macroscopic Analysis of Chest x-rays, Chest CT and Chest MRI and Digitized Tissue Layer Sectional Analysis

FIG. 7 illustrates the integrated system for high intensity digitized macroscopic chest x-ray, chest CT, and chest MRI and digitized tissue layer sectional analysis. It incorporates all the components described in FIGS. 1-6. The system is configured as into a system that is conveniently placed on a desktop 146. The high-resolution digital camera 30 with the camera stand 36 and the illumination section 10 is placed in a camera cabinet 148 to which the x-ray films for digitization can be fed into. It incorporates the section for digital image processing with a computer and image processing algorithms 14, the section 20 with a server, workstations, display monitor 104 and printers 106, the section for processed image conversion as DICOM compliance archive 18 and the section with removable disc storage devices 22. Details of each of these sections and components have been described earlier.

FIG. 8: Examples of Tone Curves that are used for Digital Tissue Sectioning

FIG. 8 shows examples of the tone curves used for the digital tissue sectioning. In FIG. 8 example of the tone curve, tone curve 1, 150 that was used to enhance the digitized chest x-ray image is shown. Several tone scales are constructed after a series of testing on the effects of tone-scales on digitized images to differentiate various structures by adjustments of contrast and brightness and they were saved. During image processing, these tone curves are recalled for digital tissue sectioning.

### Preferred Embodiment—Operation

Operation of the present invention is described with reference to FIGS. 1-6.

The system of FIG. 1 operates in the following manner. The hard copy film image that is to be digitized is placed on top of the even lighted x-ray trans-illumination light box 24 in the illumination section 10 for illuminates the source image. The film is fixed in place with the film-holder and light field adjustment device 26. The image is digitized in image digitizing section 12 With the preferred high-resolution digital camera 30. It is selected from the group of CCD high-resolution digital microscope camera 28, camera scanner 32, and CCD high-resolution interchangeable single lens reflex digital camera 54, with a view camera 66 with ultra high-resolution CCD scanning digital camera back 64 or any other high and super-high resolution digital cameras. The high-resolution digital camera 30 is attached to the camera stand 36 with spring loaded camera attachment device 40 to which the high-resolution digital camera 30 is fitted with the screwing device 42. The interchangeable lens 34 is fitted to the camera. With the spring loaded camera attachment device 40, the camera is moved upwards or downwards on the column of the camera stand 38 to focus the image on the even lighted x-ray trans-illumination light box 24 and the camera is locked in position with the camera stand locking screw 44. The focusing distance is read from the vertical distance marker 46 on the column of the copy stand 38. Through SCSI interface connections 52 or by USB digital interface 62, the high-resolution digital camera 30 is connected to the section for digital image processing with a computer and image processing algorithms 14. It is also connected to the external removable storage discs from the group of external removable high volume storage drives E 126, external removable high volume storage drives F 128 or external removable high volume storage drives G 130. Before capture of the digitized image, the image perspectives are corrected in the preview grid features in the section for digital image processing with a computer and image processing algorithms 14. The exposure time, contrast, brightness, gamma and sharpness of the digitizing image are automatically adjusted by the image capturing software to give a standardized optical density irrespective of the varying optical densities of the mammographic films. The digitized images are captured in TIFF file format or in any similar convenient file format that can be processed in any of the selected algorithm. Alternatively, the digitized images are captured and stored on to a smart media card 116 and the images are transferred from the smart media 116 through USB digital interface 62 to the computer. A file captured in TIFF format can also be processed by the DICOM 3. The software assisted digitized image analysis of this invention facilitates a standardized optical density of the digitized image irrespective of the optical density of the optical density of the original film image. The image perspectives are automatically corrected and are shown in the preview grid features in the section for digital image processing with a computer and image processing algorithms 14. The images are captured and stored onto a hard disc in the section for digital image processing with a computer and image processing algorithms 14 where the digitized, captured image is further processed with image processing algorithms 16. Examples of such image processing algorithms 16 includes image processing software of the high-resolution digital camera 30, Adobe PhotoShop, Corel Photopaint, Epix's Interactive Image Analysis software, x-cap and other such image processing software. This analysis is not limited to any one of such commercially available software but they are given as simple examples of software that can be used with this invention. With these image manipulation software, a dry-lab image processing such as adjustments of contrast, brightness, gamma, sharpness, tonescale adjustments, edge detection, arithmetic processing etc are done.

Digital image enhancement is done with the tone scale, brightness and contrast adjustments to further enhance the visualization of clinically significant structures such as the pulmonary fibrosis, tumors and other such important image components. Trained skilled technicians do such dry-lab digital image processing in the section for digital image processing with a computer and image processing algorithms 14, the “Medical Image Digital PhotoShop”. The processed images are stored onto storage discs and recalled for comparative readings by side by side displaying both the original and digitized and processed images. The digitized images are displayed onto display monitors or they are printed as hard copy prints. The reading specialists like radiologists and physicians make such comparative readings. The processed images are made ready for reading as displayed onto the monitors by the click of a mouse or a button by the specialists who reads such images. The original film images are made ready to read by the specialists by placing them onto backlighted view boxes, as it is the present practice in this art. When such processed image is made as DICOM compliance, the processed image is transferred to section for processed image conversion as DICOM compliance archive 18 with DICOM 3.0 or higher compliance software. There are many such DICOM 3.0 or higher compliance commercially available software. Each patient's processed image is stored onto a removable storage discs 110 as processed image with or without DICOM compliance from the groups of external removable high volume storage drive E 126, external removable high volume storage drive F 128, external removable high volume storage drive G 130. A high volume removable storage disc 110 is used for chronological archive and retrieval of serial film images such as chest x-rays, chest CT and MRI of a patient ranging for many years. Images are also stored onto hard disk in hard disc drive 82 or other suitable large volume image storage medium like tape medium. In the sections for digital image processing with a computers 4, image processing algorithms 16, DICOM compliance 18, server, workstations, display and printers, 20 and storage discs the digitized image is further processed with image processing algorithms and the processed archived images are recalled and viewed on the monitors at workstations 102, or display monitors 104 that are attached to it or they are reviewed from hard copy print that are printed with printers 106. The processed, archived, stored images are also recalled and viewed on the monitors at section for digital image processing with a computer and image processing algorithms 14. Alternatively the image is viewed as it is projected onto a screen with a LCD projector 106.

The CCD high-resolution digital microscopic camera 28, the CCD high-resolution interchangeable single lens reflex digital camera 54, or the view camera 66 with its high-resolution CCD scanning digital camera back 64 can either be attached to the camera stand 36 or to a tripod 56 and directed towards a wall 53 with the wall mounted illumination section 10 as shown in FIG. 3A. The images are captured as described before. The LCD image viewfinder 58 of the CCD high-resolution interchangeable single lens reflex digital camera 54 is used to preview the image. In the case of CCD high-resolution digital microscopic camera 28, adjusting the interchangeable lens 34 focuses the image and the digitized image is captured and stored in a reflex camera's storage medium 60. The digital interface of this captured image is made through USB digital interface 62 or by transfer of the reflex camera's storage medium 60 to removable storage drives, to removable storage unit A 88 or to removable storage unit B 90 in the section for digital image processing with a computer and image processing algorithms 14. As described before, in the sections for digital image processing with a computer 14, image processing algorithms 16, DICOM compliance 18, server, workstations, display and printers, 20 and storage discs the digitized, captured image is further processed with image processing algorithms and stored and the processed, archived and stored images are recalled and viewed on the monitors at workstations 98, or monitors 104 attached to it or they are reviewed from hard copy print that are printed with printers 106. The processed, archived, stored images are also recalled and viewed on the monitors at section for digital image processing with a computer and image processing algorithms 14. Alternatively the image is viewed as it is projected onto a screen with a LCD projector 110.

In the case of the view camera 66 with its high-resolution CCD scanning digital camera back 64, when it is attached to the camera stand 36, additional support and adjustment means are used to hold the camera in place. Alternatively it is held in place on a tripod 56 and directed towards the wall 53 on which the illumination section 10 is mounted as illustrated in FIG. 3A. In this case a stronger tripod 56 is used. The images are acquired as described before. The camera is connected to the section for digital image processing with a computer and image processing algorithms 14 through SCSI interface connections 52. The image perspectives are corrected in the preview grid features in the section for digital image processing with a computer and image processing algorithms 14. As described for other cameras, in the sections for digital image processing with a computer 14, image processing algorithms 16, DICOM compliance 18, server, workstations, display and printers, 20 and storage discs the digitized, captured image is further processed with image processing algorithms and stored and the processed, archived and stored images are recalled and viewed on the monitors at workstations 102, or monitors 104 attached to it or they are reviewed from hard copy print that are printed with printers 108. The processed, archived, stored images are also recalled and viewed on the monitors at section for digital image processing with a computer and image processing algorithms 14. Alternatively the image is viewed as it is projected onto a screen with a LCD projector 106.

The integrated system for high Intensity digitized macroscopic image analysis with tissue layer section as shown in FIG. 7 facilitates the routine practice of this invention with a compact integrated system in a working environment of a dry-lab medical digital image analysis. Skilled technicians can conveniently processes the image by practicing the methods of operation of this invention. The hard copy film images are placed on to the illumination system 10 with even lighted x-ray trans-illumination light box 24 with film holder and light field adjustment device 26. This illumination system is placed on a drawer of the desk like cabinet to which this system is integrated. The digital camera 30 with a smaller camera stand is encased in a smaller cabinet that stands on top of the U-shaped desk cabinet. The digital camera with the lens 34 is directed towards the illumination system with the hard copy film images. Films are changed easily by hand or in cases of large volume use by means of a commercially available automatic film feeder. The captured image signals are processed with the image processing algorithms 16 as described before.

### Other Embodiments

Low Cost Digital Camera, TV Camera Combined with a Frame Grabber or Scanners—Description

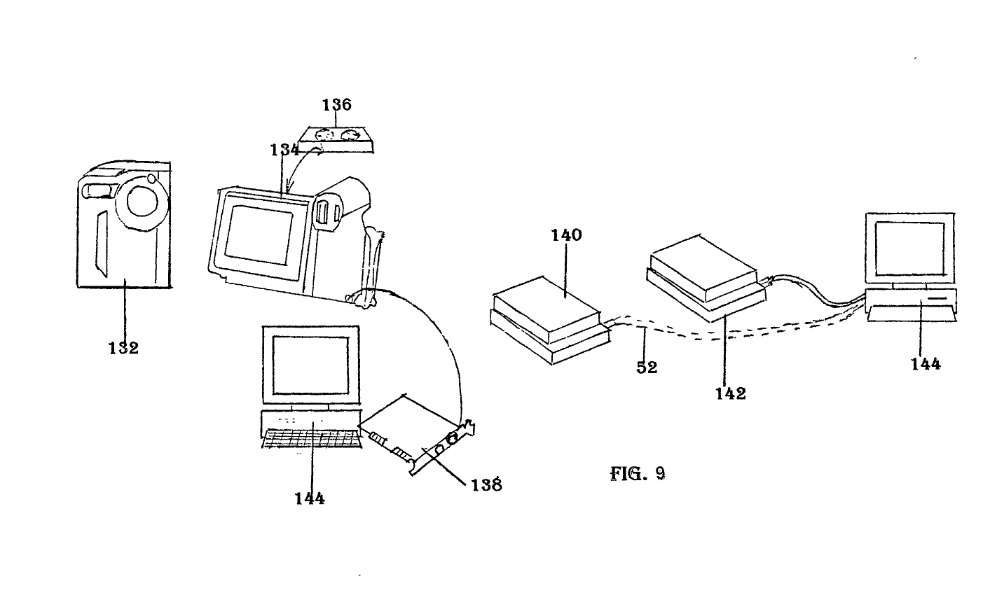

FIG. 9 Indirect Digital Image Acquisition and Image Processing with Low Cost Digital Camera, TV camera with a Frame Grabber or with Scanners

FIG. 9 Illustrates the means for indirectly digitized image captures with lower cost digital camera 132, TV camera camcorder 134. Newer lower cost high-resolution digital cameras are becoming increasingly available. The digitized image is stored onto a Floppy Disc 112, a PC Card 114, or a Smart Media 116. Such storage media is inserted to such disc reader devices of a PC or Macintosh computer 144 and the digital image is processed under software control. The TV camera camcorder 134 records the captured images onto camcorder's videotape 136. The images from the videotape are transferred to a PC or Macintosh computer 144 by means of a frame grabber 138.

Low Cost Digital Camera, and TV Camera with Frame Grabber

The hard copy images recorded on to film are placed on to the illuminating box and illuminated with the even lighted x-ray trans-illumination light box 24 in the illumination section 10. Indirectly digitized images are captured with the lower cost digital cameras 132 and the digitized image is stored onto a Floppy Disc 112, a PC Card 114, or a Smart Media 116. Such storage media is inserted to such disc reader of a PC or Macintosh computer 144 and the digital image is processed under software control. The images are captured and stored onto a camcorder's videotape 136. Such images are transferred from the camcorder's videotape 136 to a PC or Macintosh computer 144 for conversion of the analog image to digital image. The interfacing frame grabber 138 converts the camcorder's analog image to digital image. The digitized images are then processed as before for improved visualization of the diagnostically important structures contained in a hard copy image recorded on to a film. These systems have lower resolutions and therefore they have lesser image qualities. For digital macroscopy, the CCD and super CCD digital camera gives very high-resolution image. It is because of its ability to scan small sized images with the CCD camera's full high resolution. The resolution of the CCD camera is not dependent on the size of the scanned field, as it is in the case of a laser scanner or a CCD scanner.

### Printed Examples of Digitized Processed Images

Printed examples of images recorded on to films and which were digitized and processed according to this invention are illustrated in the following figures. To minimize the number of such figures included in these examples, only a few representative figures are included. Unless otherwise stated, the images shown here were captured with the Fujifilm's FinePix S1 Pro Super CCD digital camera with AF-Zoom Nikkor, 35-70 mm f/2.8 D lens with macro focusing capability or Polaroid digital camera DME le with the Navitar zoom lens 7000. In the case of image capture with Polaroid camera, the 48-bit image's color was subtracted during the process of image capture. Most often these images were captured with a setting of 66 ms exposure and automatic software controlled settings for brightness, contrast and gamma. Most often, these automatic setting settings for brightness, contrast and gamma were at 50%. Based upon the processing condition of the x-ray film, the software adjusted the brightness, contrast, and the gamma values upwards or downwards from these average values. The sharpness was kept at 100%. When the Fujifilm's FinePix S1 Pro Super CCD digital camera was used for the digitized image capture, the camera was set at high resolution and the captured images were processed with the image processing algorithms. The radiographic images were backlighted with a standard x-ray view box with fluorescence lighting. For labeling of text and numbers, the images were processed with Corel Draw 9 software. For printing, these images have to be reduced to 15-20% of its Corel Draw 9 processed original size. The images were printed with a printer with 1200 dpi. Because of the above image file size reduction in the printed images, lesser details are appreciated in these prints. On the computers monitor screen even after file size reduction, more details of these images are seen than in these prints.

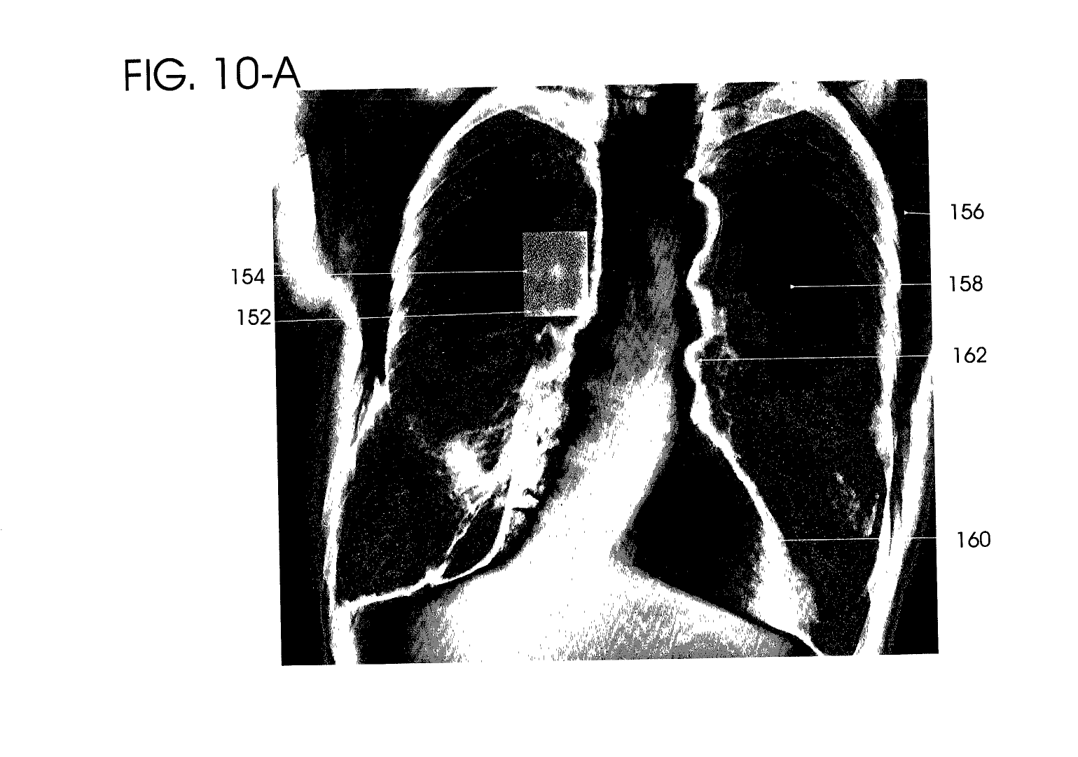

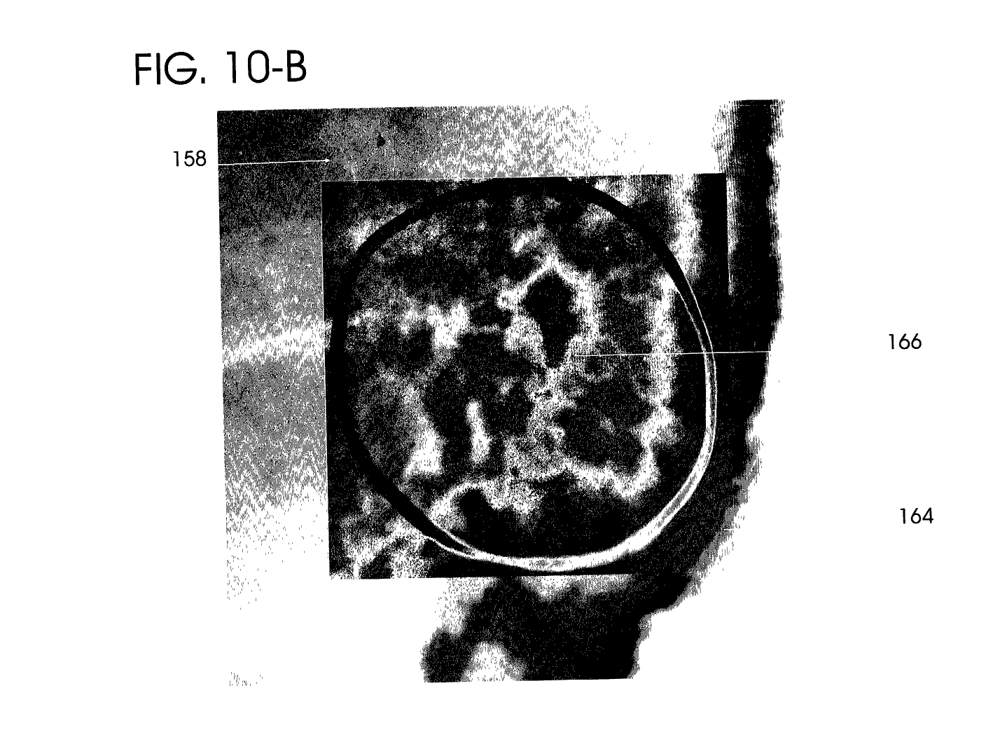

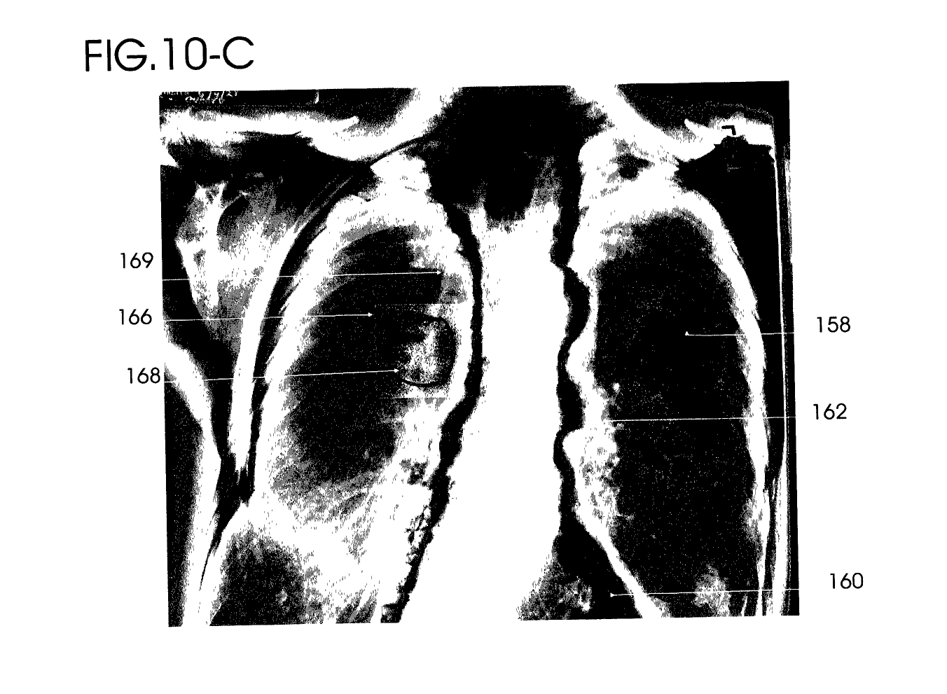

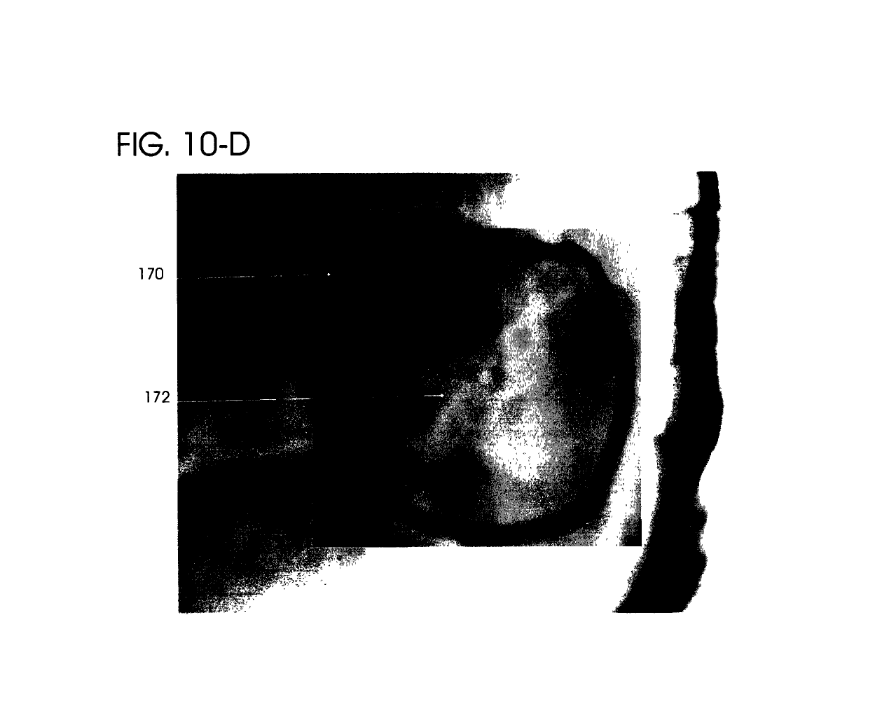

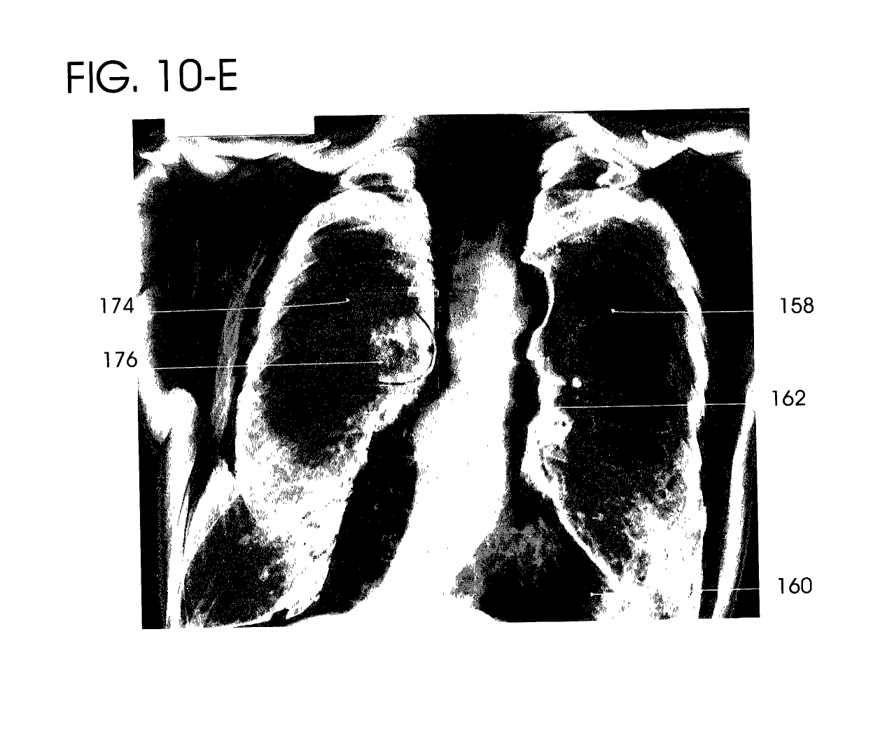

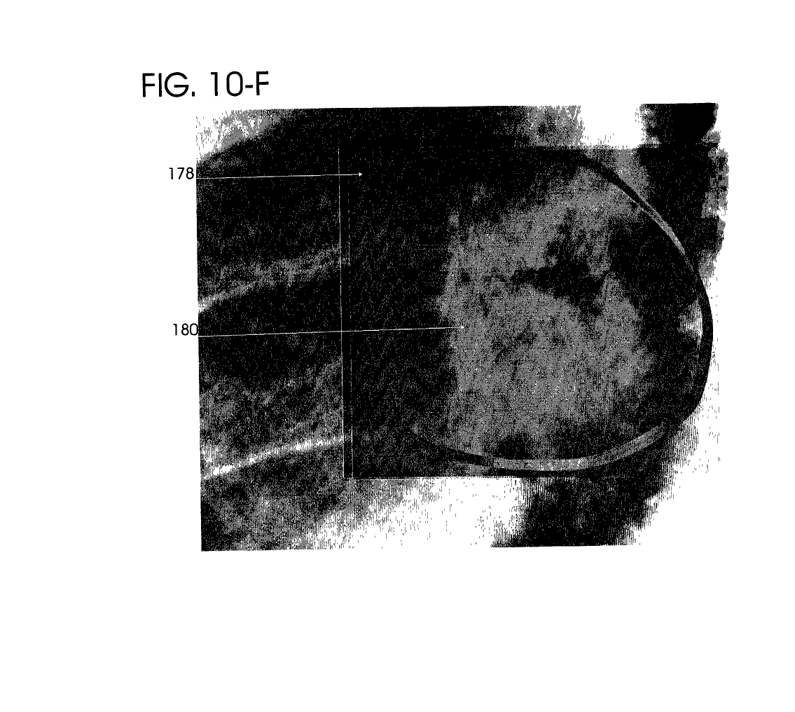

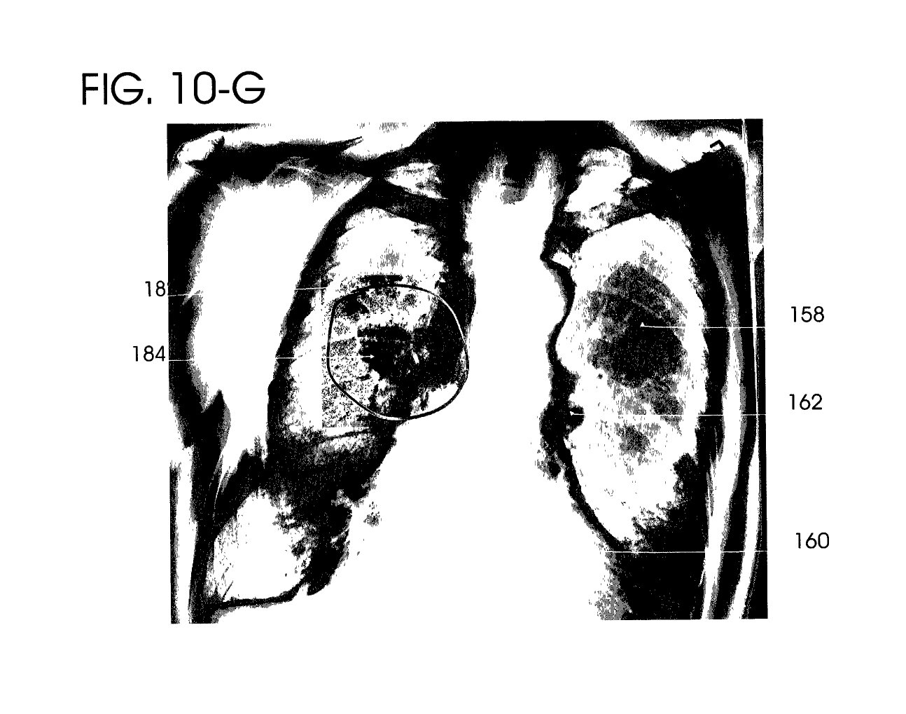

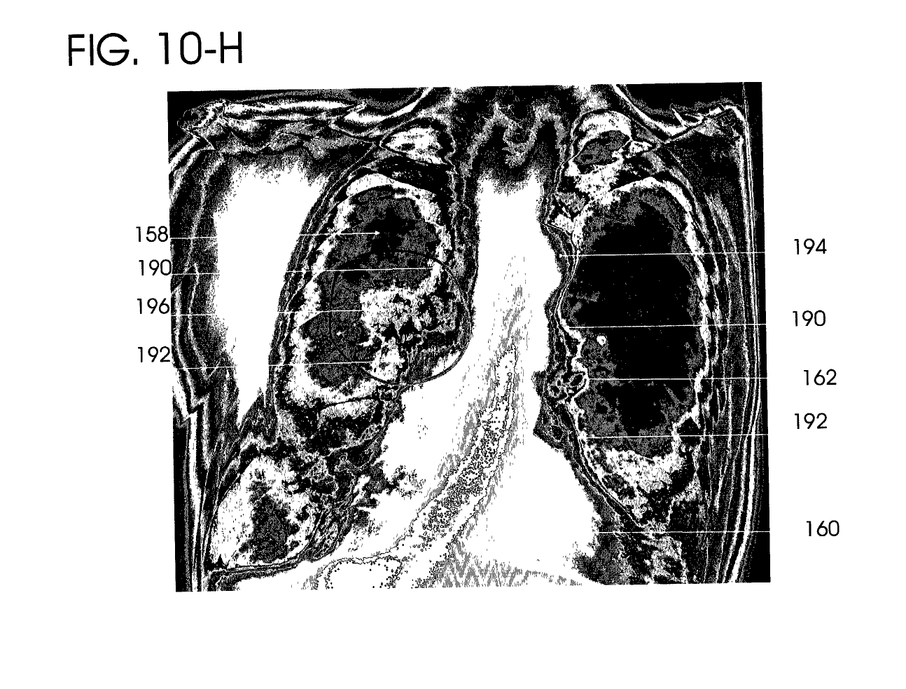

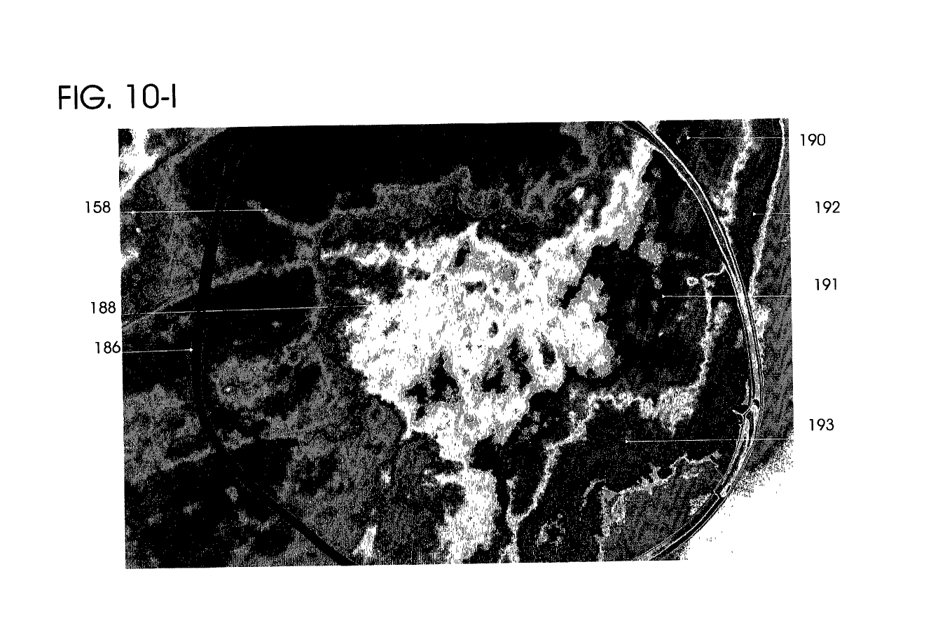

FIG. 10-A is a reduced sized print of a digitized chest x-ray of a patient taken in 1995. There was an evolving mass located close to the mediastinum. This mass could not be read from its undigitized original chest x-ray of 1995.

FIG. 10A is a 20% reduced size print of a digitized chest x-ray of a patient. The digitized image was captured with the Fujifilm's FinePix S1 Pro Super CCD digital camera at 3040×2016 resolution and auto focusing with the AF Zoom-Nikkor 35-70 mm lens. Using the Corel Photopaint 9 algorithm, this digitized image's brightness, contrast and intensity were adjusted. Subsequently, this digitized processed image was treated with the mediastinum tone curve 150A. By such image processing, a density became apparent at the right upper lobe of the lung, close to the mediastinum. The region of this density was marked and further processed by color enhancement. At the center of this marked, color-enhanced region 152, a tumor nodule 154 could be seen. This image was then converted to a 48-bit image. The original, undigitized 1995 chest x-ray of this patient was read as negative for any suspicious malignant growth. The other structures shown in the image include the chest wall 156, the lung 158, the heart 160 and the mediastinum 162.

FIG. 10-B is a reduced sized print of the close up view digitized image captured from the region of the evolving mass that was located as close to the mediastinum as shown in FIG. 10-A, 1995 chest x-ray. This mass could not be read from its undigitized original chest x-ray of 1995.

FIG. 10-B is a 15% reduced size print of the close up view digitized image captured from the highlighted region with the tumor nodule shown in FIG. 10A, from the original 1995 chest x-ray. The digitized image was captured with the Fujifilm's FinePix S1 Pro Super CCD digital camera at 3040×2016 resolution at macro focusing of at about 0.9 ft with the AF Zoom-Nikkor 35-70 mm lens. Using the Corel Photopaint 9 algorithm, this digitized image's brightness, contrast and intensity were adjusted and the captured image's 24-bit RGB tiff file format was converted to 48-bit image. Subsequently, this digitized processed image was treated with the mediastinum tone curve 150A. The region with the tumor was marked and further processed by color enhancement. Within this close up view color enhanced region 164 the magnified ill-defined tumor mass with irregular boarders 165 is shown. The original, undigitized 1995 chest x-ray of this patient was read as negative for any suspicious malignant growth.

FIG. 10-C is a reduced sized print of a digitized 1996 chest x-ray of the same patient whose chest x-ray taken a year ago and is illustrated in FIG. 10-A and FIG. 10-B. There was an evolving mass with tumor angiogenesis located close to the mediastinum. This mass could not be read from its undigitized original chest x-ray of 1996.

FIG. 10C is a 20% reduced size print of the digitized 1996 chest x-ray of the same patient whose digitized chest x-rays are shown in FIG. 10-A and FIG. 10B. Like before, the digitized image was captured with the Fujifilm's FinePix S1 Pro Super CCD digital camera at 3040×2016 resolution and auto focusing with the AF Zoom-Nikkor 35-70 mm lens. Using the Corel Photopaint 9 algorithm, this digitized image's brightness, contrast and intensity were adjusted. Subsequently, it was processed with the mediastinum tone curve 150A. By such image processing, the tumor in the right upper lobe of the lung, close to the mediastinum became more visible. The region of this density was marked and further processed by color enhancement. At the center of this 1996 chest x-ray's marked, color-enhanced region 166, a larger than 1995 tumor nodule 168 and the apparent tumor blood vessel 169 ending in the tumor mass could be seen. This image was then converted to a 48-bit image. Like in the original 1995 chest x-ray, the original, undigitized 1996 chest x-ray of this patient was also read as negative for any suspicious growth. The lung 158, the heart 160 and the mediastinum 162 are also shown in this image.

FIG. 10-D is a reduced sized print of the close up view digitized image captured from the region of the evolving mass shown in FIG. 10-C, 1996 chest x-ray. This mass could not be read from its undigitized original chest x-ray of 1996.

FIG. 10-D is a 15% reduced size printing of the close up view digitized image captured from the highlighted region with the tumor nodule shown in FIG. 10C, from the original 1996 chest x-ray. Like before, the digitized image was captured with the Fujifilm's FinePix S1 Pro Super CCD digital camera at 3040×2016 resolution at macro focusing of at about 0.9 ft with the AF Zoom-Nikkor 35-70 mm lens. Using the Corel Photopaint 9 algorithm, this digitized image's brightness, contrast and intensity were adjusted and the captured image's 24-bit RGB tiff file format was converted to 48-bit image. Subsequently, this digitized processed image was treated with the mediastinum tone curve 150A. The region with the tumor was marked and further processed by color enhancement. Within this 1996 close up view color enhanced region 170 an ill-defined solid tumor mass with irregular boarders 172 is shown. The original, undigitized 1996 chest x-ray of this patient was read as negative for any suspicious growth.

FIG. 10-E is a reduced sized print of a digitized 1998 chest x-ray of the same patient whose chest x-ray taken in 1995 and 1996 are illustrated in FIG. 10-A, FIG. 10-B and in 1996, FIG. 10-C and FIG. 10-D. There was an evolving mass located close to the mediastinum. This mass could not be read from its undigitized original chest x-ray of 1998.

FIG. 10E is a 20% reduced size print of the digitized 1998 chest x-ray of the same patient whose digitized chest x-rays are shown in FIGS. 10-A, B, C and D. Like before, the digitized image was captured with the Fujifilm's FinePix S1 Pro Super CCD digital camera at 3040×2016 resolution and auto focusing with the AF Zoom-Nikkor 35-70 mm lens. Using the Corel Photopaint 9 algorithm, this digitized image's brightness, contrast and intensity were adjusted. Subsequently, it was processed with the mediastinum tone curve 150A. By such image processing, the tumor in the right upper lobe of the lung, close to the mediastinum became even more visible. The region was marked and further processed by color enhancement. At the center of this 1998 chest x-ray's marked, color-enhanced region 174, a larger than 1996 tumor mass 176 could be seen. This image was then converted to a 48-bit image. Like in the original 1995 and 1996 chest x-rays, the original, undigitized 1998-chest x-ray of this patient was also read as negative for any suspicious growth. The lung 158, the heart 160 and the mediastinum 162 are also shown in this image.

FIG. 10-F is a reduced sized print of the close up view digitized image captured from the region of the evolving mass shown in FIG. 10-E, 1998 chest x-ray. This mass could not be read from its undigitized original chest x-ray of 1998.

FIG. 10-F is a 15% reduced size printing of the close up view digitized image captured from the highlighted region with the tumor nodule shown in FIG. 10E, from the original 1998 chest x-ray. Like before, the digitized image was captured with the Fujifilm's FinePix S1 Pro Super CCD digital camera at 3040×2016 resolution at macro focusing of at about 0.9 ft with the AF Zoom-Nikkor 35-70 mm lens. Using the Corel Photopaint 9 algorithm, this digitized image's brightness, contrast and intensity were adjusted and the captured image's 24-bit RGB tiff file format was converted to 48-bit image. Subsequently, this digitized processed image was treated with the mediastinum tone curve 150A. The region with the tumor was marked and further processed by color enhancement. Within this 1998 close up view color enhanced region 178, an ill-defined larger solid tumor mass with irregular boarders 180 is shown. This mass was not obvious in the original routine chest x-rays of 1995, 1996 and 1998 and hence they were read as negative for any suspicious tumor mass.

FIG. 10-G is a reduced sized print of a digitized 1999 chest x-ray of the same patient whose digitized chest x-ray's prints of 1995, 1996 and 1998 are shown in FIGS. 10-A and 10-B, 1995, in FIGS. 10-C and 10-D, 1996 and in FIGS. 10-E and 10-F, 1998. A tumor located in the right upper lobe, close to the mediastinum became now obvious and it was read from its undigitized original chest x-ray.

FIG. 10-G is a 20% reduced size print of the digitized 1999 chest x-ray of the same patient whose digitized chest x-rays are shown in FIGS. 10-A, B, C, D, E and F. Like before, the digitized image was captured with the Fujifilm's FinePix S1 Pro Super CCD digital camera at 3040×2016 resolution and auto focusing with the AF Zoom-Nikkor 35-70 mm lens. Using the Corel Photopaint 9 algorithm, this digitized image's brightness, contrast and intensity were adjusted. Subsequently, it was processed with the mediastinum tone curve 150A. By this time, there was an easily visible tumor mass in the right upper lobe. It was located at the same site as the tumor mass seen in the earlier digitized chest x-rays, namely in the right upper lobe, close to the mediastinum. It was read as suspicious for malignancy. On biopsy, it was found to be a squamous cell carcinoma of the lung. Like before, the region with the tumor was marked and further processed by color enhancement. In this 1999 chest x-ray's marked, color-enhanced region 182, a still larger than 1998 tumor mass 184 could be seen. This image was then converted to a 48-bit image. Although in the original chest x-rays of 1995, 1996 and 1988 this tumor was not so obvious and hence it was not reported from the original chest x-rays, by now this squamous cell carcinoma of the lung has become so obvious and it was reported. The lung 158, the heart 160 and the mediastinum 162 are also shown in this image.

FIG. 10-H is a reduced sized print of the digitized and processed 1999 chest x-ray as in FIG. 10-G but treated with a different tone cure to demonstrate the advanced stage of the tumor, stage T₃ due to tumor invasion to both visceral and mediastinal pleura.

FIG. 10-H is a 20% reduced size print of the digitized 1999 chest x-ray captured like the FIG. 10-G, namely with the Fujifilm's FinePix S1 Pro Super CCD digital camera at 3040×2016 resolution and auto focusing with the AF Zoom-Nikkor 35-70 mm lens. Using the Corel Photopaint 9 algorithm, it was then processed with the mediastinum tone curve 150B instead of mediastinum tone curve 150A. By this processing of the digitized image, it was possible to delineate the visceral pleura 190, the mediastinal pleura 192 and the pericardium 194. The tumor is shown to invade both the visceral pleura 190 and the mediastinal pleura 192. When the lung cancer invades to the mediastinal pleura, it becomes an advanced stage difficult to cure tumor, stage T₃ tumor. Such demonstration of visceral pleura 190 and mediastinal pleura 192 and tumor invasion to visceral pleura 190 and mediastinal pleura 192 from a chest x-ray was not feasible by any other previously known art. Similarly, the demonstration of the pericardium from a chest x-ray was not possible by any other previously known art. Such distinct visualization of visceral pleura, mediastinal pleura and the pericardium will help the early diagnosis of diseases affecting these structures like asbestosis, mesothelioma, and tumors invading the pericardium. The lung 158, the heart 160 and the mediastinum 162 are also shown in this image.

FIG. 10-I is a reduced sized print of the close up view digitized image captured from the region of the reported tumor mass shown in FIG. 10-G, 1999 chest x-ray. FIG. 10-I is a 15% reduced size printing of the close up view digitized image captured from the highlighted region with the tumor nodule shown in FIG. 10H, from the original 1998 chest x-ray. Like before, the digitized image was captured with the Fujifilm's FinePix S1 Pro Super CCD digital camera at 3040×2016 resolution at macro focusing of at about 0.9 ft with the AF Zoom-Nikkor 35-70 mm lens. Using the Corel Photopaint 9 algorithm, the digitized image was cropped and displayed with lesser-reduced image size. Within this 1999 close up encircled region 186, an ill-defined much larger squamous cell carcinoma 188 is shown. The tumor 196 is shown to invade both visceral pleura 191 and the mediastinal pleura 193. This pleural invasion makes this tumor as an advanced, stage T₃ tumor that has poor prognosis. The normal uninvolved visceral pleura 190, the mediastinal pleura 192 and the lung are also shown. The demonstration of tumor invasion to both visceral and the mediastinal pleura so distinctively was not feasible by any previously known methods of medical imaging including from a chest x-ray. Although this tumor appeared as a small tumor and not showing any distinct pleural invasion in chest x-ray and the CT-scans, it could have considered as an early stage T₁ tumor, a tumor less than 3 cm and surrounded by normal visceral pleura. This tumor was present in the lung for four years before it was finally diagnosed from the chest x-ray. Once the suspicion of a tumor is reported in the chest x-ray, additional follow up diagnostic investigations, including the chest CT scan and biopsy of the suspected tumor will follow. Hence the chest x-ray is the most important preliminary studies in the diagnosis of lung cancer. In this patient, if the suspicion of an evolving tumor through the digitized analysis of the chest x-ray was available, the diagnosis and treatment of the lung cancer could have initiated much earlier. Furthermore, the distinct visualization of visceral pleura 190, and mediastinal pleura 192 aids the deferential diagnosis of diseases affecting such structures like malignant tumors, mesothelioma and asbestosis.

FIG. 10-J is a reduced sized print of the digitized and processed close up view 1999 chest x-ray as shown in FIG. 10-H but treated with a different tone cure for a closer observation of this advanced stage, stage T₃ tumor with tumor invasion to both visceral and mediastinal pleura.

FIG. 10-J is a 15% reduced size print of the close up view digitized 1999 chest x-ray captured like the FIG. 10-H, namely with the Fujifilm's FinePix S1 Pro Super CCD digital camera at 3040×2016 resolution and macro focusing with the AF Zoom-Nikkor 35-70 mm lens. Using the Corel Photopaint 9 algorithm, it was then processed with the mediastinum tone curve 150B instead of mediastinum tone curve 150A. By this processing of the digitized image, it was possible to delineate the visceral pleura 190, the mediastinal pleura 192 and the pericardium 194. The tumor is shown to invade both the visceral pleura 190 and the mediastinal pleura 192. When the lung cancer invades to the mediastinal pleura, it becomes an advanced stage tumor, stage T₃ tumor. This close up view illustrates the visceral pleura 190, mediastinal pleura 192 and the pericardium 194, the tumor 196, the tumor invasion to the visceral pleura 198 and tumor invasion to mediastinal pleura 200 better than in FIG. 10-I. Such demonstration of visceral, mediastinal pleura, pericardium and the extension of the tumor to such structures from a chest x-ray were not feasible by any other previously known art.

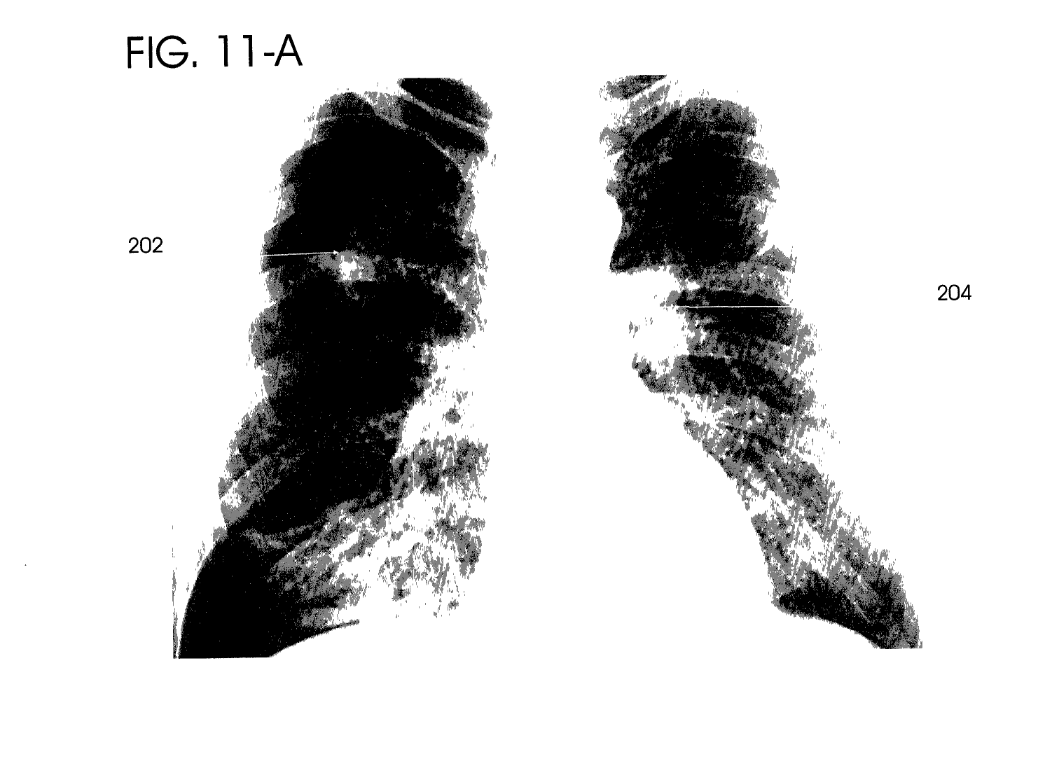

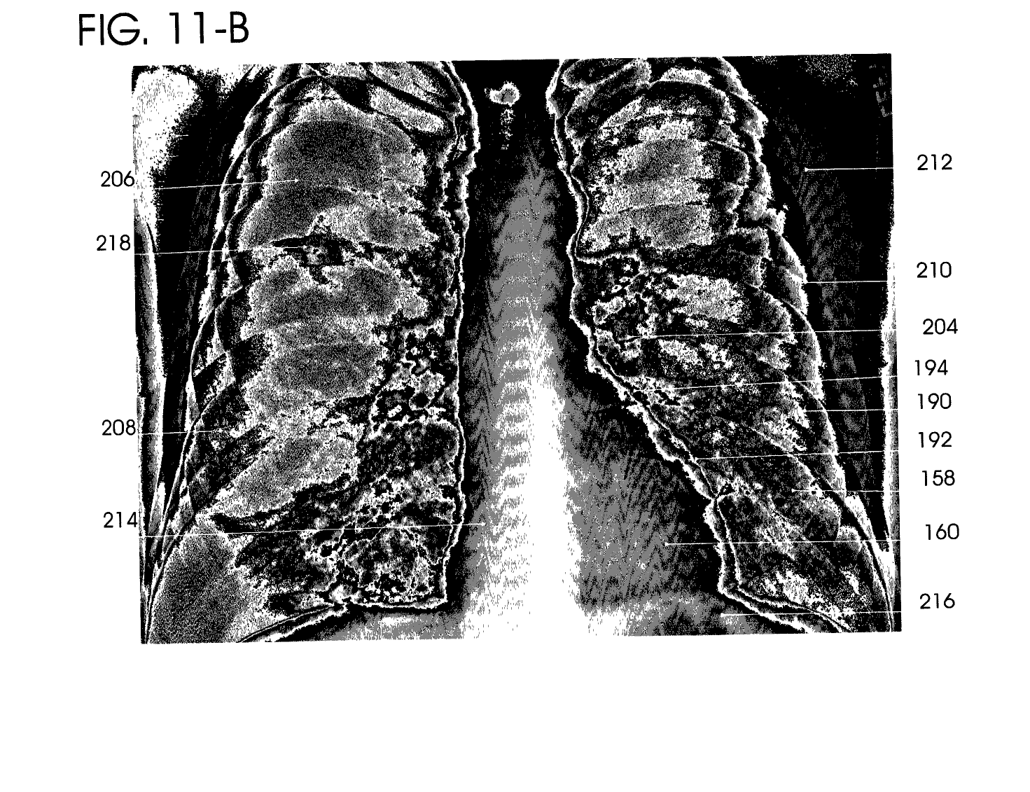

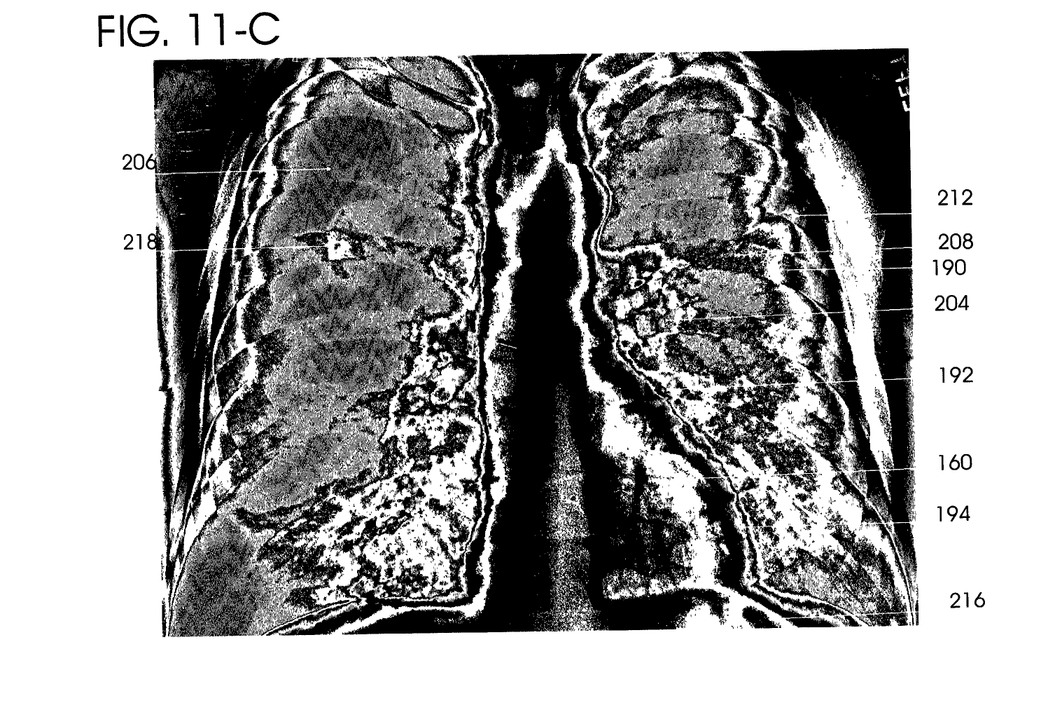

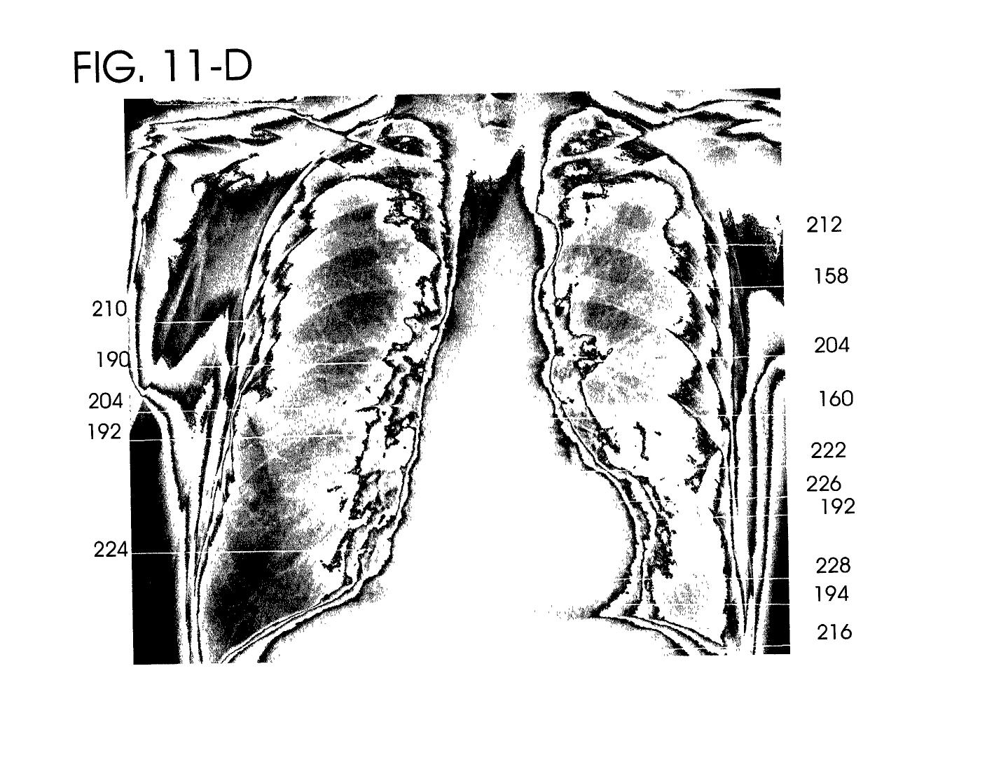

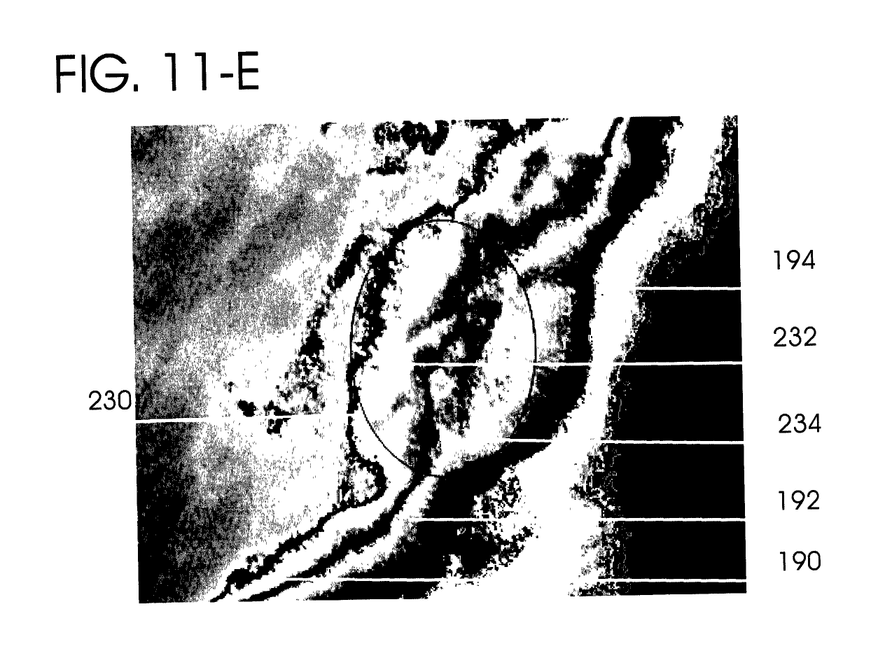

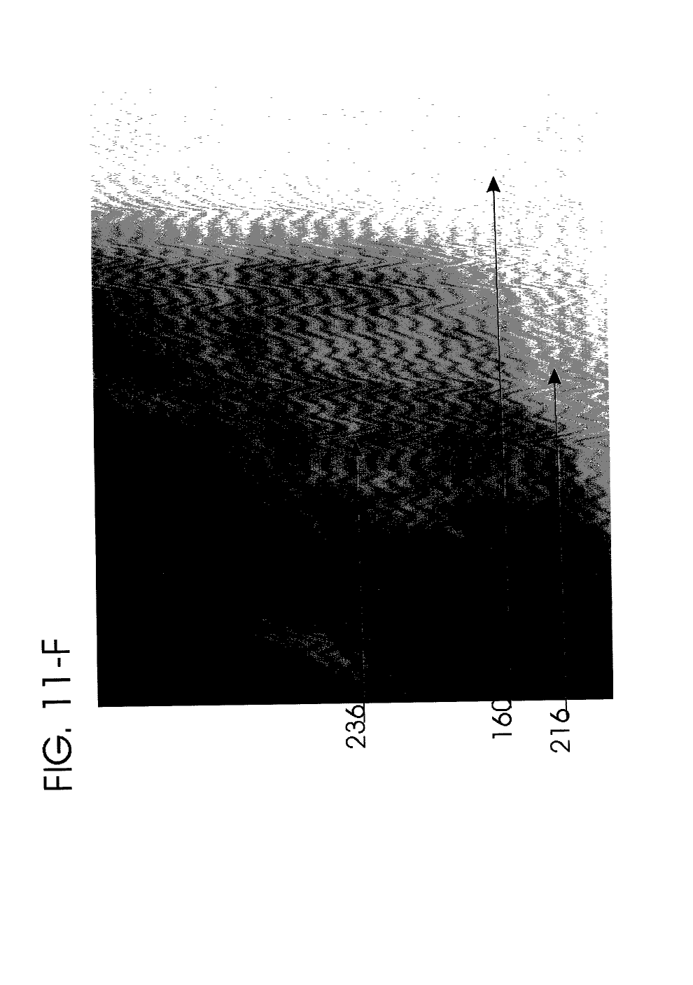

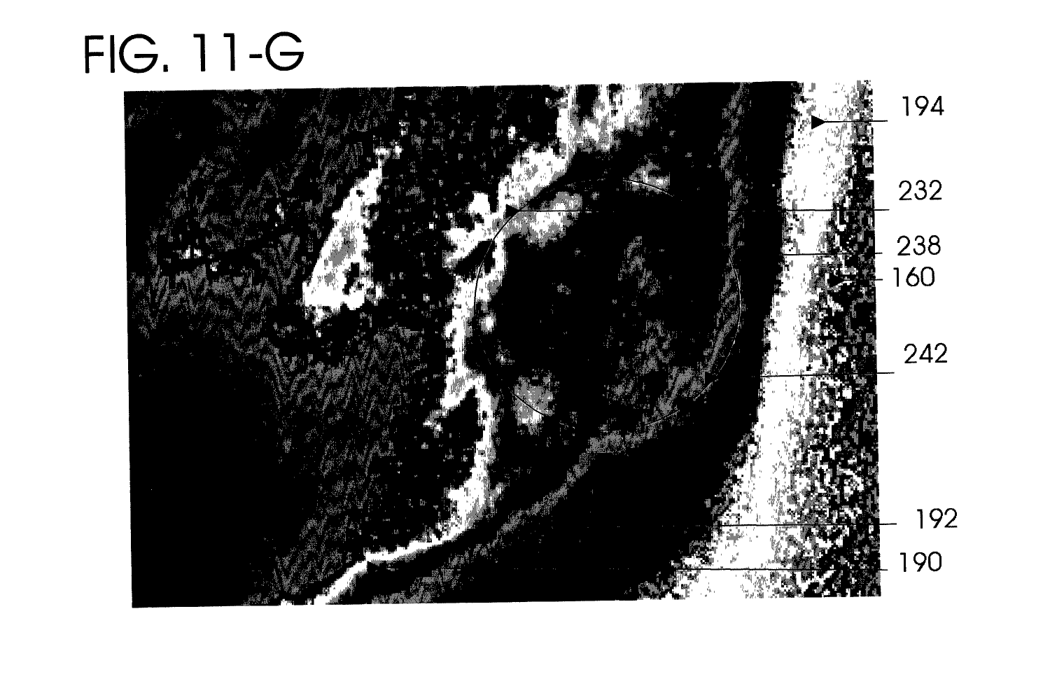

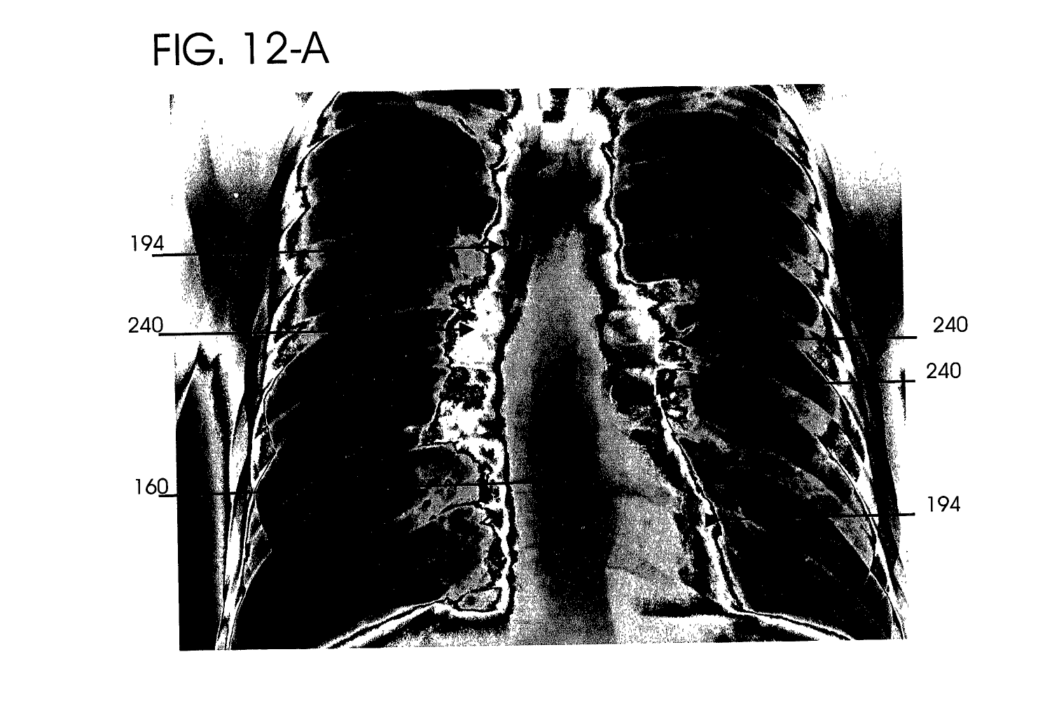

FIG. 11-A is a reduced sized print of a high-resolution digitized chest x-ray of a patient with early stage pneumoconiosis and a suspicious mass in the lung requiring the differential diagnosis of a malignant growth or a developing pneumoconiotic mass.

FIG. 11-A is a 20% reduced size print of the digitized chest x-ray captured from the original chest x-ray of a patient with early pneumoconiosis. It was digitized with the Fujifilm's FinePix S1 Pro Super CCD digital camera at 3040×2016 resolution and auto focusing with the AF Zoom-Nikkor 35-70 mm lens. A circumscribed pneumoconiotic opacity 202 is seen in the right upper lobe of the lung. This high-resolution indirect digitization of the chest x-ray rendered the better visualization of the circumscribed pneumoconiotic opacity 202 than it was in the original chest x-ray. The pneumoconiosis associated hilar lymphadenopathy 204 is also better visualized in this digitized chest x-ray than it was in the original chest x-ray.

FIG. 11-B is a reduced sized print of an 8-bit gray scale image converted from the digitized image shown in FIG. 11A. It was further treated by left-shift arithmetic processing for enhanced visualization of the diffuse early stage pneumoconiotic changes in the lung and the organs of the chest.

FIG. 11B illustrates the extensive early stage pneumoconiotic disease in the same patient's chest x-ray that was shown in FIG. 11A. This 20% reduced size print was prepared from the digitized image shown in FIG. 11-A. The digitized image was captured with the Fujifilm's FinePix S1 Pro Super CCD digital camera at 3040×2016 resolution and auto focusing with the AF Zoom-Nikkor 35-70 mm lens and it was first converted to a 8 bit grayscale image. The image in 8-bit or 16-bit format was found to give identical results by left shift arithmetic processing. Subsequent two pass treatment with left-shift arithmetic processing rendered this chest image with distinct visualization of the diffuse aggregates of large pinhead sized round opacities 206 throughout the both lungs. They were not visible in FIG. 11-A, the image that was not subjected to left shift arithmetic processing. The next larger granular pneumoconiotic regions are seen as with denser pneumoconiotic deposits 208. This is a great innovation that facilitates the distinct visualization of diffuse very early stage, developing pneumoconiosis of the lung. In this instance, the early stage pneumoconiotic small granular deposits involve both lungs diffusely. This very early stage extensive disease could not be appreciated from the undigitized and left shift arithmetic unprocessed chest x-ray. It facilitates the early detection and follows ups of very early stage pneumoconiotic disease in a patient. It will render new classification of pneumoconiosis and silicosis of the lung. Also the thoracic structures, namely the heart 160, the lung 158, visceral pleura 190, mediastinal pleura 192, the pericardium 194, the parietal pleura 210, the hilar lymph nodes 204, the ribs 212, the vertebrae 214 and the diaphragm 216 are well illustrated. The circumscribed pneumoconiotic opacity 202 seen in FIG. 11-A is viewed as an ill-defined denser pneumoconiotic opacity 218 by this image processing. This image processing also facilitates the clinical visualization of pleura of the lung and the pericardium of the heart and their anatomic relation with the structures of the chest cavity. It helps the detection and diagnosis of pleural and pericardial diseases such as asbestosis, mesothelioma, constrictive pericarditis, and tumors invading the heart, pleura and the pleural cavity. This was also not possible before.

FIG. 11-C is a reduced sized print of an 8-bit grayscale image converted from the digitized image shown in FIG. 11A. It was further treated by tone curve 150-B for comparison with left shift arithmetic processing shown in FIG. 11-B for enhanced visualization of the diffuse early stage pneumoconiotic changes in the lung and the organs of the chest.

FIG. 11C is a comparative image with FIG. 11-B. It is to demonstrate that both the left shift arithmetic and tone curve 150-B processing gives nearly the same results. Both of them shows the extensive early stage pneumoconiotic disease in the same patient's chest x-ray that was shown in FIG. 11A. This 20% reduced size print was prepared from the digitized image shown in FIG. 11-A that was captured with the Fujifilm's FinePix S1 Pro Super CCD digital camera at 3040×2016 resolution and auto focusing with the AF Zoom-Nikkor 35-70 mm lens. The captured image was then converted to an 8-bit grayscale image. The image in 8-bit or 16-bit format was found to give identical results by left shift arithmetic processing or treatment with tone curve 150-B. Subsequent one pass treatment with tone curve 150-B rendered this chest x-ray image with distinct visualization of the diffuse aggregates of large pinhead sized round opacities 206 throughout the both lungs. It is similar to that observed by left shift arithmetic processing. If the image was not treated twice with left shift arithmetic processing but only once, the pleura and the pericardium will not show as they are shown in FIG. 11-B. The once left shift arithmetic processed image is similar to this FIG. 11-C. It was treated only once with tone curve 150-B. The next larger granular pneumoconiotic regions are seen as with denser pneumoconiotic deposits 208. The early stage pneumoconiotic small granular deposits involve both lungs diffusely. It facilitates the early detection and follows ups of very early stage pneumoconiotic disease in a patient. Also the thoracic structures, namely the heart 160, visceral pleura 190, mediastinal pleura 192, the pericardium 194, the hilar lymph nodes 204, the ribs 212, and the diaphragm 216 are well illustrated. The circumscribed pneumoconiotic opacity 202 seen in FIG. 11-A is viewed as an ill-defined denser pneumoconiotic opacity 218 by this image processing. Like by left shift arithmetic processed image shown in FIG. 11-B, this image processing with tone curve 150-B also facilitates the clinical visualization of pleura of the lung and the pericardium of the heart and their anatomic relation with the structures of the chest cavity. Both these methods help the detection and diagnosis of pleural and pericardial diseases such as asbestosis, mesothelioma, constrictive pericarditis, and tumors invading the heart, pleura and the pleural cavity. This was also not possible before.

FIG. 11-D is a comparative reduced sized print of a 16-bit grayscale digitized and left shift arithmetic processed chest x-ray print as the FIG. 11-B of an elderly patient with behind the heart pulmonary metastasis and no pneumoconiosis.

FIG. 11D is a comparative 20% reduced sized print of a similar 16-bit grayscale digitized and left shift arithmetic processed chest x-ray as the FIG. 11-B. As before, the digitized image was captured with the Fujifilm's FinePix S1 Pro Super CCD digital camera at 3040×2016 resolution and auto focusing with the AF Zoom-Nikkor 35-70 mm lens. It was then converted to a 16-bit grayscale image. Subsequently the 16-bit image was treated twice with left-shift arithmetic processing. It is similar to the image if it were treated with tone curve 150-B as described in FIG. 11-C. In comparison with the FIG. 11-B, in this instance there are no pneumoconiotic changes including no diffuse aggregates of pinhead sized round opacities throughout the both lungs. The large round aggregates of two metastatic nodules 220 behind the left ventricle 222 of the heart 160 is better defined by this processing than it was in the original chest x-ray. If the brightness of the image were reduced, these metastatic nodules would become more distinct. Thus the left shift arithmetic processing of a grayscale digitized chest x-ray helps to improve the visualization of the hidden diseases like the metastasis behind the heart. Because of the brightness and contrast interference, the pulmonary diseases like the metastasis hidden behind the heart is often difficult to visualize. The left shift arithmetic processing of the grayscale digitized chest x-ray makes other smaller metastasis 224 less visible than it were in the original chest x-ray. The thoracic structures, the heart 160, the lung 158, visceral pleura 190, mediastinal pleura 192, the pericardium 194, the parietal pleura 210, the hilar lymph nodes 204, the ribs 212, and the diaphragm 216 are also illustrated by this image processing. The importance of visualization of visceral pleura 190, mediastinal pleura 192, the pericardium 194, and the parietal pleura 210 as distinct structures by such image processing cannot be overemphasized. It was not possible before. It helps the diagnosis of diseases affecting such structures from the chest x-rays easier than from the original undigitized and unprocessed chest x-rays.

FIG. 11-E is a cropped up image prepared from the digitized chest x-ray print shown in FIG. 11-D with a right lower lobe pulmonary metastasis to illustrate the finer details of the metastatic tumor.

FIG. 11-E is a full sized print of the cropped up region with the right lower lobe pulmonary metastasis 224 shown in FIG. 11-D. The original digitized full sized image was too large to be displayed with all its details in the 20 percent reduced size print shown in FIG. 11-D. To illustrate more details of this pulmonary metastatic tumor 224 shown in FIG. 11-D, this tumor-bearing region in FIG. 11-D was cropped up with the image-processing algorithm. Because of the much lower total pixel size of this cropped up region's image as compared to the digitized full sized chest x-ray image shown in FIG. 11-D, the print of the cropped up region with the pulmonary metastatic tumor 224 could be made at its full size. The image in FIG. 11-D was treated with left shift arithmetic processing. The left shift arithmetic processing made it possible to delineate the visceral pleura 190, the mediastinal pleura 192 and the pericardium 194. It is also shown in FIG. 11-D but in this full sized print the separation of visceral pleura 190, mediastinal pleura 192 and the pericardium 194 is better illustrated. The encircled September 1999 right lower lobe metastatic tumor 230 shows this tumor nodule as involving both the visceral pleura and the mediastinal pleura. The visceral pleura with metastatic tumor 232 and the mediastinal pleura with metastatic tumor 234 are shown to be as the components of the pulmonary metastatic tumor 224 seen in FIG. 11-D. In the routine chest x-ray, its appearance was just like a round nodular shadow. The electronic full sized review of the cropped up image in a computer's monitor or as its full sized print enables the detailed analysis of the of the tumor and its extension to the surrounding tissue. Such detailed analysis of the tumor from a chest x-ray was not feasible before.

FIG. 11-F is a print of the cropped up digitized image captured from a six months earlier chest x-ray of the same patient whose six months later digitized cropped up chest x-ray print with pulmonary metastasis is shown in FIG. 11-E. It illustrates the presence of a tumor nodule in this earlier digitized chest x-ray but its original undigitized chest x-ray was read as negative for metastatic disease.

FIG. 11-F is a cropped up image captured from a six months earlier chest x-ray of the same patient whose six months later digitized cropped up and left shift arithmetic processed chest x-ray with pulmonary metastasis is shown in FIG. 11-E. Its original six months earlier chest x-ray was read as negative for metastatic disease. However, in retrospective review of the original chest x-ray, a tumor nodule was suspected in the right lower lobe of the lung. It was located at the same site as it was in the six months later chest x-ray. As before, this six months earlier chest x-ray was digitized with the Fujifilm's FinePix S1 Pro Super CCD digital camera at 3040×2016 resolution and auto focusing with the AF Zoom-Nikkor 35-70 mm lens. When the digitized image was reviewed at its full size in the computer's monitor, this metastatic tumor nodule became obvious. It was located at the same site as the encircled September 99 right lower lobe metastasis 230 shown in FIG. 11-E. Because of the much lower total pixel size of this cropped up region's image, it could be printed at its 150 percent size. It gives a magnifying effect and illustrates the tumor nodule well. Thus, this March 99 undiagnosed right lower lobe metastasis 236 was made as a distinct tumor nodule lying close to the heart 160 and the diaphragm 216. It illustrates the advantages of the high resolution digitized image analysis of chest x-rays for diagnosis of difficult to visualize very early stage lung cancer.

FIG. 11-G is a one and half times magnified print of the same digitized cropped up image illustrated in FIG. 11-F but after treatment with tone curve 150-B.

FIG. 11-G is the same cropped up image as in FIG. 11-F but it was treated with tone curve 150-B to highlight the details of this tumor. It is almost identical to the cropped up, left arithmetic processed image with pulmonary metastasis shown in FIG. 11-E. Like in FIG. 11-E, the processing with tone curve 150-B made it possible to delineate the visceral pleura 190, the mediastinal pleura 192 and the pericardium 194. The encircled March 1999 unread right lower lobe metastatic tumor 238 shows the visceral pleura with metastasis 232. The tumor extends towards the mediastinal pleura without tumor invasion 242, as it is the case in six months later. The six months later image, the FIG. 11-E shows both the visceral pleura with metastatic tumor 232 and the mediastinal pleura with metastatic tumor 234. The illustration of the mediastinal pleura without tumor invasion 242 in six months earlier and mediastinal pleura with metastatic tumor 234 six months later as shown in FIG. 11-E demonstrates the evolution of this metastasis in the course of six months period. In the tone curve 150-B untreated cropped image shown in FIG. 11-F, this March 99 undiagnosed right lower lobe metastasis 236 appeared as a round nodular shadow. Such detailed analysis of the tumor from a chest x-ray was not feasible before. It aids in the determination of tumor invasion and tumor staging. Like before, because of the much lower total pixel size of this cropped up region's image, it could be printed at its 150 percent size. It gives a magnifying effect and illustrates the tumor nodule well. Thus, this March 99 undiagnosed right lower lobe metastasis 236 was made as a distinct tumor nodule lying close to the heart 160. It illustrates the advantages of the high resolution digitized image analysis of chest x-rays for diagnosis of difficult to visualize very early stage lung cancer.

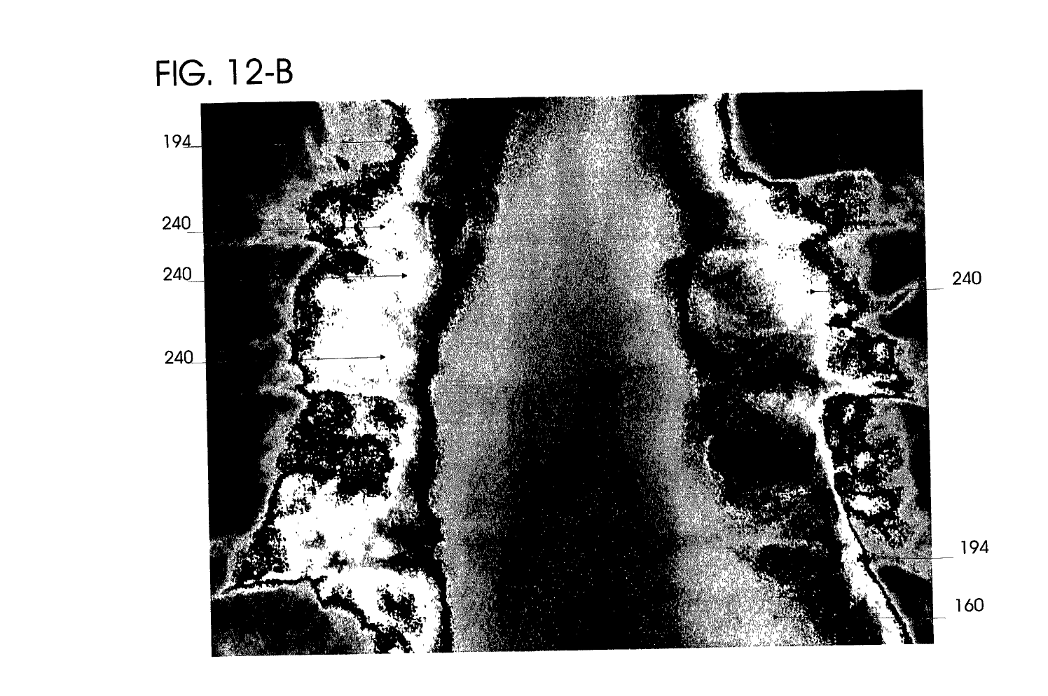

FIG. 12A is a 20 percent reduced sized print of a 48-bit digitized grayscale image of a chest x-ray of a patient with pulmonary sarcoidosis after it was treated with tone curve 150-B.

FIG. 12A is a 20% reduced sized print of a 48-bit grayscale digitized and tone curve 150-B treated chest x-ray of a patient with sarcoidosis. The enlarged hilar-mediastinal lymph nodes of sarcoidosis 240 are better visualized by this image processing. As before, the digitized image was captured with the Fujifilm's FinePix S1 Pro Super CCD digital camera at 3040×2016 resolution and auto focusing with the AF Zoom-Nikkor 35-70 mm lens. It was then converted to a 48-bit grayscale image. Subsequently the 48-bit image was treated with the tone curve 150-B. In spite of this patient's interstitial pulmonary disease associated with sarcoidosis, there are no diffuse pulmonary granular changes like that of pneumoconiosis. Comparison of this image with similarly digitized and tone curve 150-B treated chest-x-ray image shown in FIG. 11-C illustrates this difference. Both the left shift arithmetic processing and the tone curve 150-B treatment of the digitized image makes the pneumoconiotic changes more visible. Thus, when this image is compared with FIG. 11-B, the twice left shift arithmetic processed chest x-ray image of a patient with known pneumoconiosis it becomes obvious that the interstitial pulmonary changes associated with diseases like sarcoidosis do not have the same characteristic pulmonary changes as the pneumoconiosis. Other enhanced thoracic structures, the heart 160, and the pericardium 194 are also illustrated in this FIG. 12-A.

FIG. 12-B is a full sized print of the cropped up portion of the digitized chest x-ray image shown in FIG. 12-A to illustrate the grossly enlarged hilar mediastinal lymph nodes of sarcoidosis and to aid for its differential diagnosis from metastatic lymph nodes.

FIG. 12-B is a full sized print of the cropped up portion of the digitized chest x-ray image shown in FIG. 12-A. Because of the much lower total pixel size of this cropped up region's image, it could be printed at its full size which gives a magnifying effect. It further illustrates the hilar mediastinal lymph nodes of sarcoidosis 240 as well circumscribed nodular masses with smooth surface. If it were of malignant lymph nodes, they would have appeared as with irregular contour and irregular surface. Thus image processing described here will also help to make the differential diagnosis metastatic hilar mediastinal lymph nodes versus enlarged lymph nodes associated with diseases other than malignancy. The pericardium 194 and the heart 160 are also made as more distinct structures in this image.

### Conclusions, Ramifications, and Scope

Accordingly the reader will see that according to this invention, I have provided a method for the diagnosis of slowly evolving lung cancer and pulmonary diseases that are invisible or difficult to see in chest x-rays with a system consisting of high and super-high resolution digitized image analysis. These methods of image analysis include capture of high and super-high resolution digitized images from chest x-rays and analysis of the digitized images with digital image analyzing algorithms. For digital macroscopy, close up view digitized images are captured from a region of interest from the original chest x-rays. Adjustments of brightness and contrast, color and tone curve assisted image processing are used for the enhanced view of the digital image. The close-up view digital macroscopy allows magnified view of a region of interest without much noise interference. It facilitates the very early detection of chronically developing lung cancer and lung diseases. This method and the system of chest-x-ray image analysis of this invention shows that it takes about 3-4 years before a lung cancer is usually diagnosed from a chest x-ray. Due to contrast interference, the very early stage evolving tumors are usually not from the chest x-rays. This methods of image processing overcomes this contrast interference and makes the evolving tumors more readily recognizable. Chest x-ray is the most commonly used initial method for the diagnosis of lung diseases including lung cancer. Once the suspicion for an early evolving tumor nodule is made, it is usually followed by chest CT-scans and or MRI, PET scans bronchoscopy and the histological confirmation of the tumor by biopsy. An early stage tumor nodule made visible in a chest x-ray by the methods of this invention in a patent with no known infection and the PET scan showing an increased metabolic activity in it have a higher chance of being a very early stage evolving lung cancer. This facilitates the diagnosis of lung cancer several years before it becomes as very obvious in routine chest x-rays. This invention's methods of image processing also allows the diagnosis of very early stage pneumoconiosis, silicosis, visualization of visceral, mediastinal and parietal pleura and the pericardium as distinct structures in the digitized processed chest x-ray. Such visualization of these structures in a chest x-ray or in any other medical imaging was not possible before. It facilitates better very early detection of diseases affecting such structures.

The image processing system consists of image capturing digital cameras, particularly of high and very high-resolution digital camera that may be any from a group of analog or digital cameras or line scanning digital cameras that is connected directly or indirectly to a PC or Mac computer 32, attached peripherals for digitized high resolution image capture, routing, storage, display and printing and a networking server system for image storage, routing and display of multiple comparative images at multiple viewing stations simultaneously. The networking server system may be any from a group of servers, routers, switches and hubs. The digitized and software assisted processed images are displayed at multiple display workstations for simultaneous comparative image analysis of multiple images. They can also be recorded onto a hard recording medium. The display unit may also be from any of the groups of display monitors or digital image projector 42, attached to the PC or Mac computer 32, or to the viewing workstations 58. The image processing software may be any from the groups of suitable image processing software. The system is simple to install and operate, reliable, and economical. It is readily applicable as a side by side comparative image analysis system with that of conventional radiological images.

While the above description contains much specificity, these should not be construed as limitations on the scope of the invention, but as exemplification of the presently-preferred embodiments thereof. Many other ramifications and variations are possible within the teachings to the invention. For example, the digitized image can be processed with image processing software in many other different ways including with different tone curves for enhanced view of different structures but within the scope of this invention. This digitized image capture and processing system can be built into an imaging system like a x-ray unit. Different arrangements can be used for the image capture including with that of a line scanner, digitization, storage and processing of the digitized image with a mainframe computer, image analysis with image processing software of varying kind, use with a Picture Archival and Communication System (PACS), display of comparative multiple images to a screen with multiple electronic image projecting devices attached to multiple workstations of a networking server system and computer aided detection and diagnosis of masses from chest x-ray and chest CT and MRI that are recorded onto a hard medium. Accordingly, the scope of this invention should be determined by the appended claims and their legal equivalents, and not by the examples given.

What is claimed is:

1. A method for cost efficient high, super-high and ultra-high resolution digitized image analysis of chest x-rays with image processing algorithms for diagnosis of slowly evolving lung cancer and pulmonary diseases that are invisible or difficult to see in routine chest x-rays.

2. A method for cost efficient high, super-high and ultra-high resolution digitized image analysis of chest x-rays of claim 1 for diagnosis of slowly evolving lung cancer and pulmonary diseases that are invisible or difficult to see in routine chest x-rays, with a system comprising of:
(a) image digitizing means comprising of high, super high and ultra-high resolution digital cameras for digitized image acquisition,
(b) image processing means as image processing algorithms,
(c) image storage means as a computer's fixed or removable hard disc, or external hard disc,
(d) means for digital networking,
(e) means for image display onto computer monitors and as print or image display onto screens by means of LCD projectors,
(f) means for such processed image printing

3. A method of cost-efficient image analysis according to claim 1 for the detection of invisible very small evolving lung cancer in chest x-rays by suppression of contrast interference by high and super high resolution digitized and software assisted image analysis.

4. A cost-efficient system according to claim 1 for assessment of the extent of tumor growth including the biologically active latent tumor that is present in the screen film chest x-ray but it is invisible due to contrast interference and to make it visible by close up digitized image capture and color, brightness and contrast adjustments.

5. A cost-efficient system according to claim 1 for assessment of the extent of tumor growth including the biologically active latent tumor that are present in the screen film chest x-ray but it is invisible due to contrast interference and to make them visible by digitized image analysis.

6. A method of claim 1 for evaluating diagnostically important image data contained in a chest x-ray by improved high resolution digitized image analysis by image capture at high bit depth including at 12-bit, 16 bit, 24 bit and 48 bit with high, super-high and ultra-high resolution CCD digital cameras and image processing algorithms and displaying of such processed image on computer monitors or its projection onto screens by means of electronic LCD projectors or to print them onto hard mediums at higher dpi for improved recognition of normal and abnormal structures and thereby improved diagnosis of lung cancer and pulmonary disease by skilled diagnostic experts.

7. A method of claim 1 to use different window levels to standardize the optical density of the digitized chest x-ray to compensate the differences in optical density of screen film chest x-rays due to wide range of exposures used in image acquisition, patient's sizes, differences in tissue composition of the chest and lung tissue and chemical processing of screen film radiographs to show conspicuousness of a lesion and to make it easier to see.

8. A method of evaluating diagnostically important image data contained in a chest x-ray of claim 1 by sizing and orientation, copy and paste, palette and pixel analysis, convolution, edge detection and modification, pixel and pair arithmetic, binning, contrast modification, histogram analysis, morphology and histogram measurements for improved diagnosis of lung diseases including lung cancer and pulmonary diseases by skilled diagnostic experts.

9. A method of claim 1 wherein said evaluation of screen-film chest x-rays to facilitate the practical utilization of the theoretical spatial resolution of the film used in screen-film chest x-rays by its digitized and contrast enhanced image analysis with modern larger CCD and super CCD digital cameras and contrast enhancement with image processing algorithms for the detection of smaller than the tumor masses that can be detected in a routine chest x-ray and thereby to improve the diagnostic sensitivity of screen film chest x-ray for improved detection of evolving early stage lung cancer and pulmonary diseases.

10. A method of evaluating diagnostically important image data contained in a chest x-ray by improved high resolution digitized image analysis of claim 1 by storing such processed image onto individual removable hard discs that are designated for each patients imaging medical history and its recall and display onto monitors for side by side analysis with recent such processed chest x-rays for improved diagnosis of lung cancer and pulmonary diseases.

11. A method of claim 1 wherein said evaluation of digitized and software assisted image analysis of chest x-rays for a second reading to improve the diagnostic sensitivity and classification of benign and malignant diseases of the lung.

12. A method of claim 1 wherein said evaluation of digitized and software assisted image analysis of chest x-rays for a second reading to improve the diagnosis of lung cancer hidden behind the cardiac shadow which are difficult to detect from the routine chest x-rays.

13. A method of claim 1 wherein said evaluation of high resolution digitized and software assisted chest x-ray images as a second reading to facilitate improved detection and differential diagnosis of gradually increasing small densities with irregular boarders or bilobulated small masses as probable lung cancer.

14. A method of claim 1 wherein said evaluation of high resolution digitized and software assisted chest x-ray images to facilitate improved detection and diagnosis of proliferative pulmonary diseases including the malignant proliferative disorders.

15. A method of claim 1 wherein said evaluation of high resolution digitized and software assisted chest x-ray images to facilitate improved detection and differential diagnosis of tumor with groups of distorted bronchi, hypervascularity, and distorted parenchyma.

16. A method of claim 1 wherein said evaluation of high resolution digitized and software assisted chest x-ray images for improved detection and differential diagnosis of the thickened bronchus and bronchiolar diseases.

17. A method of claim 1 wherein said evaluation of high resolution digitized and software assisted chest x-ray images for improved detection and differential diagnosis of asymmetric pulmonary segmental densities, focal or segmental lung tissue retraction and atelectasis as signs of evolving pulmonary diseases including lung cancer.

18. A method of claim 1 wherein said evaluation of high resolution digitized and software assisted chest x-ray images for detection of neoangiogenesis in evolving early stage lung cancer.

19. A method of claim 1 wherein said evaluation of high resolution digitized and software assisted chest x-ray images for improved visualization of convergent blood vessels to pulmonary mass as a sign of angiogenesis associated with lung cancer and its differentiation from benign causes of angiogenesis in the absence of a positive history for acute lung injuries such as surgical wounds, trauma, infection and or abscess.

20. A method of claim 1 wherein said evaluation of high resolution digitized and software assisted chest x-ray images to improve the detection of the hilar and mediastinal lymph nodes and its differential diagnosis of enlarged lymph nodes associated with malignant diseases like lung cancer and nonmalignant diseases like sarcoidosis.

21. A method of claim 1 wherein said evaluation of high resolution digitized and software assisted chest x-ray images to improve its diagnostic sensitivity for the detection of early evolving silicosis and coal worker's pneumoconiosis.

22. A method of claim 1 wherein said evaluation of high resolution digitized and software assisted chest x-ray images to assist the improved detection of early evolving silicosis and coal worker's pneumoconiosis and its differential diagnosis from pulmonary interstitial diseases like sarcoidosis.

23. A method of claim 1 wherein said evaluation of digitized and software assisted image analysis of chest x-rays as a means for distinct visualization of layers of visceral, mediastinal and parietal pleura and pericardium.

24. A method of claim 1 wherein said evaluation of digitized and software assisted image analysis of chest x-rays as a means for distinct visualization of diseases affecting the visceral, mediastinal and parietal pleura and pericardium.
